(19) United States
(12) Patent Application Publication
(10) Pub. No.: US 2025/0157744 A1
(43) Pub. Date: May 15, 2025

(54) MULTILAYER CERAMIC ELECTRONIC COMPONENT AND MOUNTING STRUCTURE OF MULTILAYER CERAMIC ELECTRONIC COMPONENT

(71) Applicant: Murata Manufacturing Co., Ltd., Nagaokakyo-shi (JP)

(72) Inventors: Kentaro FUJIWARA, Nagaokakyo-shi (JP); Tatsunori YASUDA, Nagaokakyo-shi (JP)

(21) Appl. No.: 19/021,403

(22) Filed: Jan. 15, 2025

Related U.S. Application Data
(63) Continuation of application No. PCT/JP2023/017199, filed on May 2, 2023.

(30) Foreign Application Priority Data
Aug. 2, 2022 (JP) 2022-123316

(51) Int. Cl. H01G 4/30; H01G 4/232

(52) U.S. Cl. CPC H01G 4/30; H01G 4/232

(57) ABSTRACT

In a multilayer ceramic electronic component, a first outer electrode includes a first base electrode layer, a first lower plating layer on the first base electrode layer, and a first upper plating layer on the first lower plating layer except for a first plating exposed region exposed on a surface of the first outer electrode so that the first lower plating layer includes the first plating exposed region, and a second outer electrode includes a second base electrode layer, a second lower plating layer on the second base electrode layer, and a second upper plating layer on the second lower plating layer except for a second plating exposed region exposed on a surface of the second outer electrode so that the second lower plating layer includes the second plating exposed region.

### CROSS REFERENCE TO RELATED APPLICATIONS

This application claims the benefit of priority to Japanese Patent Application No. 2022-123316 filed on Aug. 2, 2022 and is a Continuation Application of PCT Application No. PCT/JP2023/017199 filed on May 2, 2023. The entire contents of each application are hereby incorporated herein by reference.

### BACKGROUND OF THE INVENTION

### 1. Field of the Invention

The present invention relates to multilayer ceramic electronic components and mounting structures of multilayer ceramic electronic components.

### 2. Description of the Related Art

A multilayer ceramic capacitor includes a multilayer body and outer electrodes. The multilayer body includes an inner layer portion and outer layer portions. The inner layer portion is formed by alternately stacking a plurality of ceramic layers and a plurality of inner electrode layers in a predetermined stacking direction. The outer layer portions are formed by disposing a ceramic layer on a surface of the inner layer portion so as to sandwich the inner layer portion therebetween in the stacking direction. The plurality of inner electrode layers are exposed on both end surfaces in a length direction orthogonal to the stacking direction. The outer electrode is disposed on a surface of the end surface to be electrically connected to the inner electrode layer exposed from the end surface. The outer electrode includes a Ni plating layer for preventing solder erosion when the multilayer ceramic capacitor is mounted on a substrate using solder, and a Sn plating layer disposed on the Ni plating layer to improve solder application performance. The Ni plating layer and the Sn plating layer are usually formed by using an electrolytic plating method.

Japanese Unexamined Patent Application Publication No. 64-80011 discloses that performance of the multilayer ceramic capacitor deteriorates because of hydrogen generated by a chemical reaction in a plating step of forming a plating layer. Specifically, hydrogen generated in the plating step is absorbed into the inner electrode layer, which causes a problem such as deterioration of dielectric loss or insulation resistance due to the hydrogen. In order to solve this problem, Japanese Unexamined Patent Application Publication No. 64-80011 states, for example, that the inner electrode layer mainly composed of an Ag—Pd alloy or the like includes a metal such as Ni, thus suppressing the absorption of the hydrogen into the inner electrode layer to reduce or prevent deterioration of the ceramic layer.

However, although Japanese Unexamined Patent Application Publication No. 64-80011 states that Ni inactivates the hydrogen absorption action, according to the research of the inventors of example embodiments of the present invention, it was discovered that even when Ni or the like is included in a material forming, for example, the inner electrode layer and the outer electrode, hydrogen is absorbed into, for example, the inner electrode layer and the outer electrode, and the absorbed hydrogen is released from the metal depending on a temperature condition, which causes the deterioration of the insulation resistance due to the hydrogen. In particular, when a high temperature and high humidity load test such as a pressure cooker bias test (PCBT) is performed, the insulation resistance significantly deteriorates because of hydrogen released from the metal that has absorbed hydrogen, which may lead to deterioration of the multilayer ceramic capacitor.

### SUMMARY OF THE INVENTION

Example embodiments of the present invention provide multilayer ceramic electronic components and mounting structures of multilayer ceramic electronic components, which reduce or prevent deterioration of insulation resistance due to hydrogen.

A multilayer ceramic electronic component according to an example embodiment of the present invention includes a multilayer body including a plurality of stacked ceramic layers, a first main surface and a second main surface facing each other in a height direction, a first end surface and a second end surface facing each other in a length direction orthogonal or substantially orthogonal to the height direction, and a first side surface and a second side surface facing each other in a width direction orthogonal or substantially orthogonal to the height direction and the length direction, a plurality of first inner electrode layers on the plurality of ceramic layers and extending to the first end surface, a plurality of second inner electrode layers on the plurality of ceramic layers and extending to the second end surface, a first outer electrode on the first end surface, extending from the first end surface to a portion of the first main surface, a portion of the second main surface, a portion of the first side surface, and a portion of the second side surface, and being connected to the first inner electrode layers, and a second outer electrode on the second end surface, extending from the second end surface to a portion of the first main surface, a portion of the second main surface, a portion of the first side surface, and a portion of the second side surface, and being connected to the second inner electrode layers, in which the first outer electrode includes a first base electrode layer on the multilayer body, a first lower plating layer on the first base electrode layer, and a first upper plating layer on the first lower plating layer except for a first plating exposed region exposed on a surface of the first outer electrode so that the first lower plating layer includes the first plating exposed region, and the second outer electrode includes a second base electrode layer on the multilayer body, a second lower plating layer on the second base electrode layer, and a second upper plating layer on the second lower plating layer except for a second plating exposed region exposed on a surface of the second outer electrode so that the second lower plating layer includes the second plating exposed region.

In the above-described multilayer ceramic electronic components, since the first lower plating layer is exposed on the surface of the first outer electrode in the first plating exposed region, hydrogen in the multilayer ceramic electronic component can be released from the first plating exposed region to an outside of the multilayer ceramic electronic component. In addition, since the second lower plating layer is exposed on the surface of the second outer electrode in the second plating exposed region, hydrogen in the multilayer ceramic electronic component can be released from the second plating exposed region to the outside of the multilayer ceramic electronic component.

In a plating step of forming the first and second lower plating layers and the first and second upper plating layers, hydrogen ions are generated by a chemical reaction. These hydrogen ions may be absorbed as hydrogen into, for example, at least any of the first and second lower plating layers, the first and second inner electrode layers, and the first and second base electrode layers. With the above-described configuration, hydrogen absorbed into at least any layer (absorption layer) of the first and second lower plating layers, the first and second inner electrode layers, and the first and second base electrode layers can be released from the first and second plating exposed regions to the outside of the multilayer ceramic electronic component. Therefore, the hydrogen can be prevented from remaining absorbed into the absorption layer, and deterioration of insulation resistance due to the hydrogen can be reduced or prevented. In particular, even when the absorption layer includes a metal such as Ni that is difficult to absorb hydrogen, the deterioration of the insulation resistance of the ceramic layer can be reduced or prevented by releasing the hydrogen to the outside of the multilayer ceramic electronic component from the first and second plating exposed regions.

When the first and second plating exposed regions are provided on a first main surface side, a second main surface side becomes a mounting surface of a multilayer ceramic capacitor on a mounting substrate, and solder is mainly applied to first and second end surface sides, the hydrogen of the absorption layer can be efficiently released from the first main surface that is not applied with the solder and does not face the mounting substrate through the first and second plating exposed regions.

According to example embodiments of the present invention, it is possible to provide multilayer ceramic electronic components and mounting structures of the multilayer ceramic electronic components, which can reduce or prevent deterioration of insulation resistance due to hydrogen.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing an example of a two-terminal multilayer ceramic capacitor as a multilayer ceramic electronic component according to a first example embodiment of the present invention.

FIG. 2 is a cross-sectional view taken along a line II-II in FIG. 1.

FIG. 3 is a cross-sectional view taken along a line III-III in FIG. 1.

FIG. 4 is a cross-sectional view taken along a line IV-IV in FIG. 2.

FIG. 5 is a cross-sectional view taken along a line V-V in FIG. 2.

FIG. 6 is a side view showing an example of a two-terminal multilayer ceramic capacitor mounted on a mounting substrate using solder.

FIG. 7 is an explanatory diagram describing a calculation method according to a first example of an exposed area.

FIG. 8 is an explanatory diagram describing a calculation method according to a second example of an exposed area.

FIG. 9 is a partial cross-sectional view showing an aspect in which a base electrode layer is exposed.

FIG. 10 is a partial cross-sectional view showing another aspect in which a base electrode layer is exposed.

FIG. 11 is an external perspective view showing an example of a three-terminal multilayer ceramic capacitor according to a second example embodiment of the present invention.

FIG. 12 is a top view showing the example of the three-terminal multilayer ceramic capacitor according to the second example embodiment of the present invention.

FIG. 13 is a front view showing the example of the three-terminal multilayer ceramic capacitor according to the second example embodiment of the present invention.

FIG. 14 is a cross-sectional view taken along a line XIV-XIV in FIG. 11.

FIG. 15 is a cross-sectional view taken along a line XV-XV in FIG. 11.

FIG. 16 is a cross-sectional view taken along a line XVI-XVI in FIG. 14.

FIG. 17 is a cross-sectional view taken along a line XVII-XVII in FIG. 14.

### DETAILED DESCRIPTION OF THE EXAMPLE EMBODIMENTS

### A. First Example Embodiment

### 1. Two-Terminal Multilayer Ceramic Capacitor

As an example of a multilayer ceramic electronic component according to a first example embodiment of the present invention, a two-terminal multilayer ceramic capacitor will be described.

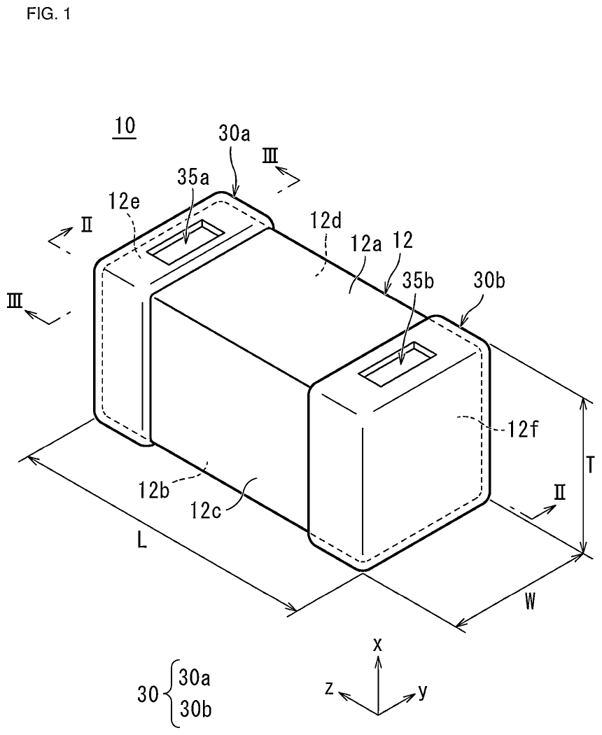

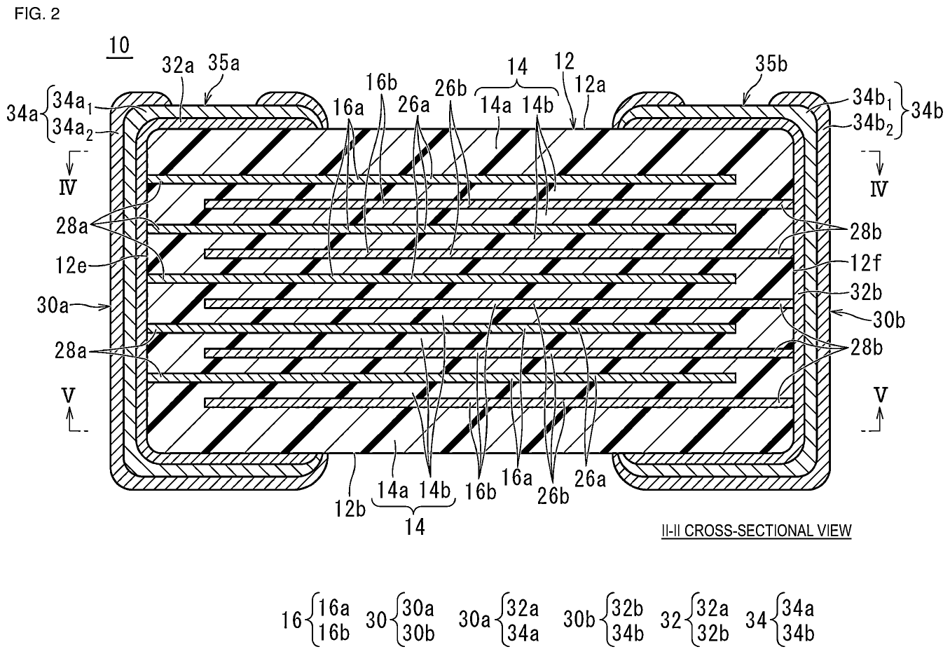

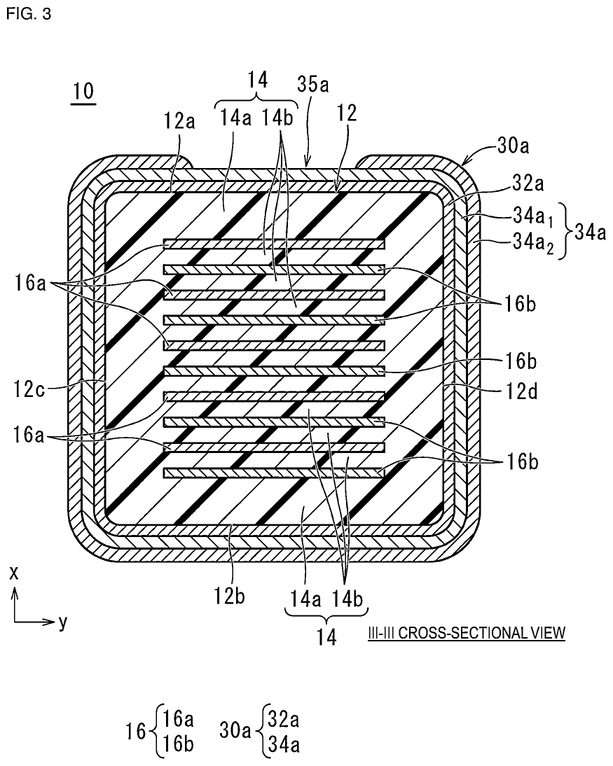

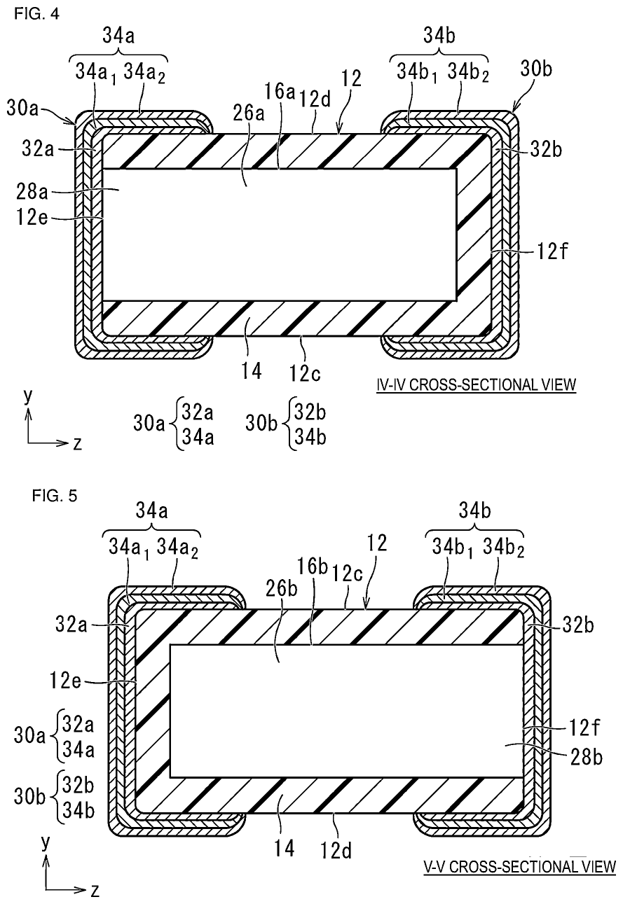

FIG. 1 is an external perspective view showing an example of the two-terminal multilayer ceramic capacitor as the multilayer ceramic electronic component according to the first example embodiment of the present invention. FIG. 2 is a cross-sectional view taken along a line II-II in FIG. 1. FIG. 3 is a cross-sectional view taken along a line III-III in FIG. 1. FIG. 4 is a cross-sectional view taken along a line IV-IV in FIG. 2. FIG. 5 is a cross-sectional view taken along a line V-V in FIG. 2.

As shown in FIGS. 1 to 3, a two-terminal multilayer ceramic capacitor 10 includes a rectangular or substantially rectangular parallelepiped multilayer body 12 and outer electrodes 30 disposed at both end portions of the multilayer body 12.

### (1) Multilayer Body

The multilayer body 12 includes a first main surface 12a and a second main surface 12b facing each other in a height direction x (stacking direction), a first side surface 12c and a second side surface 12d facing each other in a width direction y orthogonal to the height direction x, and a first end surface 12e and a second end surface 12f facing to each other in a length direction z orthogonal to the height direction x and the width direction y. The multilayer body 12 of the present example embodiment includes rounded corner portions and ridge portions. The corner portion is a portion where three adjacent surfaces of the multilayer body 12 intersect with each other, and the ridge portion is a portion where two adjacent surfaces of the multilayer body 12 intersect with each other. In addition, unevenness or the like may be provided on a portion or all of the first main surface 12a and the second main surface 12b, the first side surface 12c and the second side surface 12d, and the first end surface 12e and the second end surface 12f.

The multilayer body 12 includes outer layer portions 14a formed of a plurality of ceramic layers 14 and an inner layer portion 14b formed of one or a plurality of ceramic layers 14 and a plurality of inner electrode layers 16 disposed thereon. The outer layer portion 14a is located on a first main surface 12a side and a second main surface 12b side of the multilayer body 12. The outer layer portion 14a is an aggregate of the plurality of ceramic layers 14 (first outer layer portion) that are located between the first main surface 12a and the inner electrode layer 16 closest to the first main surface 12a, and the plurality of ceramic layers 14 (second outer layer portion) that are located between the second main surface 12b and the inner electrode layer 16 closest to the second main surface 12b. A region sandwiched between both of the outer layer portions 14a is the inner layer portion 14b. In the inner layer portion 14b, the ceramic layer 14 and the inner electrode layer 16 are alternately stacked in the height direction x.

A portion of the multilayer body 12, which is sandwiched between the first outer layer portion and the second outer layer portion and in which a first inner electrode layer 16a to be described below and a second inner electrode layer 16b to be described below face each other, is referred to as a facing portion (effective layer portion). In addition, a portion between the facing portion and the first side surface 12c and a portion between the facing portion and the second side surface 12d are also referred to as a W gap or a side gap. In addition, a portion between the facing portion and the first end surface 12e and a portion between the facing portion and the second end surface 12f are also referred to as an L gap or an end gap, and the portions include one of extended electrode portions of the first inner electrode layer 16a and the second inner electrode layer 16b.

The dimensions of the multilayer body 12 are not particularly limited.

As a dielectric material for the ceramic layer 14, for example, a dielectric ceramic including a component such as BaTiO₃, CaTiO₃, SrTiO₃, or CaZrO₃ can be used. When the dielectric material is included as a main component, a secondary component having a lower content than a main component such as, for example, a Mn compound, an Fe compound, a Cr compound, a Co compound or a Ni compound may be added according to the desired characteristics of the multilayer body 12.

When a piezoelectric ceramic material is used for the ceramic layer 14, the multilayer ceramic electronic component defines and functions as a piezoelectric component. Specific examples of the piezoelectric ceramic material include a PZT (lead zirconate titanate) ceramic material.

In addition, when a semiconductor ceramic material is used for the ceramic layer 14, the multilayer ceramic electronic component defines and functions as a thermistor element. Specific examples of the semiconductor ceramic material include a spinel-based ceramic material.

In addition, when a magnetic ceramic material is used for the ceramic layer 14, the multilayer ceramic electronic component defines and functions as an inductor element. In addition, when the multilayer ceramic electronic component defines and functions as an inductor element, the inner electrode layer 16 becomes a coil-shaped conductor. Specific examples of the magnetic ceramic material include a ferrite ceramic material.

A thickness of the ceramic layer 14 after firing is, for example, preferably about 0.35 μm or more and about 0.60 μm or less. The number of the ceramic layers 14 to be stacked is, for example, preferably 10 or more and 2000 or less. The number of the ceramic layers 14 is the total number of the ceramic layers 14 of the inner layer portion 14b and the ceramic layers 14 of the outer layer portion 14a on the first main surface 12a side and the outer layer portion 14a on the second main surface 12b side.

The multilayer body 12 includes a plurality of first inner electrode layers 16a extending to the first end surface 12e and a plurality of second inner electrode layers 16b extending to the second end surface 12f, as the plurality of inner electrode layers 16. The plurality of first inner electrode layers 16a and the plurality of second inner electrode layers 16b are embedded in the inner layer portion 14b to be alternately disposed at equal or substantially equal intervals with the ceramic layer 14 interposed therebetween along the height direction x of the multilayer body 12. Surfaces of the plurality of first inner electrode layers 16a and surfaces of the plurality of second inner electrode layers 16b are parallel or substantially parallel to the first main surface 12a and the second main surface 12b, and are, for example, rectangular or substantially rectangular in plan view.

As shown in FIG. 4, the first inner electrode layer 16a is disposed on the plurality of ceramic layers 14 and is located inside the multilayer body 12. The first inner electrode layer 16a includes a first counter electrode portion 26a facing the second inner electrode layer 16b and a first extended electrode portion 28a located on one end side of the first inner electrode layer 16a and extending from the first counter electrode portion 26a to the first end surface 12e of the multilayer body 12. An end portion of the first extended electrode portion 28a extends to a surface of the first end surface 12e and is exposed from the multilayer body 12. That is, the first extended electrode portion 28a is not exposed on the first main surface 12a, the second main surface 12b, the first side surface 12c, the second side surface 12d, and the second end surface 12f. An end portion of the first counter electrode portion 26a is spaced away in the width direction from a surface of the second end surface 12f.

A shape of the first counter electrode portion 26a of the first inner electrode layer 16a is not particularly limited, and is preferably rectangular or substantially rectangular in plan view. Meanwhile, the corner portion may be rounded corner or the corner portion may be provided obliquely (in tapered shape) in plan view. In addition, the shape may be a tapered shape in plan view that is inclined toward either direction.

A shape of the first extended electrode portion 28a of the first inner electrode layer 16a is not particularly limited, and is preferably rectangular or substantially rectangular in plan view. Meanwhile, the corner portion may be rounded corner or the corner portion may be provided obliquely (in tapered shape) in plan view. In addition, the shape may be a tapered shape in plan view that is inclined toward either direction.

A width of the first counter electrode portion 26a of the first inner electrode layer 16a and a width of the first extended electrode portion 28a of the first inner electrode layer 16a may be the same or substantially the same width, or one of the widths may be narrower.

As shown in FIG. 5, the second inner electrode layer 16b is disposed on the plurality of ceramic layers 14 and is located inside the multilayer body 12. The second inner electrode layer 16b includes a second counter electrode portion 26b facing the first inner electrode layer 16a and a second extended electrode portion 28b located on one end side of the second inner electrode layer 16b and extending from the second counter electrode portion 26b to the second end surface 12f of the multilayer body 12. An end portion of the second extended electrode portion 28b extends to a surface of the second end surface 12f and is exposed from the multilayer body 12. That is, the second extended electrode portion 28b is not exposed on the first main surface 12a, the second main surface 12b, the first side surface 12c, the second side surface 12d, and the first end surface 12e. An end portion of the second counter electrode portion 26b is spaced away in the width direction from a surface of the first end surface 12e.

A shape of the second counter electrode portion 26b of the second inner electrode layer 16b is not particularly limited, and is preferably rectangular or substantially rectangular in plan view. Meanwhile, the corner portion may be rounded corner or the corner portion may be provided obliquely (in tapered shape) in plan view. In addition, the shape may be a tapered shape in plan view that is inclined toward either direction.

A shape of the second extended electrode portion 28b of the second inner electrode layer 16b is not particularly limited, and is preferably rectangular or substantially rectangular in plan view. Meanwhile, the corner portion may be rounded corner or the corner portion may be provided obliquely (in tapered shape) in plan view. In addition, the shape may be a tapered shape in plan view that is inclined toward either direction.

A width of the second counter electrode portion 26b of the second inner electrode layer 16b and a width of the second extended electrode portion 28b of the second inner electrode layer 16b may be the same or substantially the same width, or one of the widths may be narrower.

The first inner electrode layer 16a and the second inner electrode layer 16b can be made of an appropriate conductive material such as, for example, a metal such as Ni, Cu, Ag, Pd, or Au, or an alloy including at least one of the metals such as an Ag—Pd alloy. In addition, when the multilayer body 12 including the inner electrode layer 16 and an integrated body including the outer electrode 30 on the surface of the multilayer body 12 are simultaneously fired, the metal of the inner electrode layer 16 defines a compound with the metal included in the outer electrode 30.

A thickness of the inner electrode layer 16, that is, each of the first inner electrode layer 16a and the second inner electrode layer 16b is, for example, preferably about 0.40 μm or more and about 0.50 μm or less.

In addition, the number of the first inner electrode layers 16a and the second inner electrode layers 16b is, for example, preferably about 10 or more and about 2000 or less in total.

### (2) Outer Electrode

As shown in FIGS. 1 to 3, the outer electrode 30 is disposed on the first end surface 12e side and the second end surface 12f side of the multilayer body 12.

The outer electrode 30 includes a first outer electrode 30a and a second outer electrode 30b.

The first outer electrode 30a is connected to the first inner electrode layer 16a and is disposed on at least the surface of the first end surface 12e. In this case, the first outer electrode 30a is electrically connected to the first extended electrode portion 28a of the first inner electrode layer 16a. In the present example embodiment, the first outer electrode 30a extends from the first end surface 12e of the multilayer body 12 to a portion of the first main surface 12a, a portion of the second main surface 12b, a portion of the first side surface 12c, and a portion of the second side surface 12d.

The second outer electrode 30b is connected to the second inner electrode layer 16b and is disposed on at least the surface of the second end surface 12f. In this case, the second outer electrode 30b is electrically connected to the second extended electrode portion 28b of the second inner electrode layer 16b. In the present example embodiment, the second outer electrode 30b extends from the second end surface 12f to a portion of the first main surface 12a, a portion of the second main surface 12b, a portion of the first side surface 12c, and a portion of the second side surface 12d.

In the multilayer body 12, the first counter electrode portion 26a of the first inner electrode layer 16a and the second counter electrode portion 26b of the second inner electrode layer 16b face each other with the ceramic layer 14 interposed therebetween, thus generating an electrostatic capacitance. Therefore, the electrostatic capacitance can be obtained between the first outer electrode 30a to which the first inner electrode layer 16a is connected and the second outer electrode 30b to which the second inner electrode layer 16b is connected, and the characteristics of the capacitor are provided.

The outer electrode 30 preferably includes a base electrode layer 32 and a plating layer 34. In the present example embodiment, the outer electrode 30 includes a base electrode layer 32 including a metal component and a plating layer 34 disposed on the base electrode layer 32. The plating layer 34 includes a first plating layer 34a and a second plating layer 34b.

The first outer electrode 30a includes a first base electrode layer 32a including a metal component, a first lower plating layer 34a₁ disposed on the first base electrode layer 32a, and a first upper plating layer 34a₂ disposed on the first lower plating layer 34a₁. In addition, the first outer electrode 30a includes a first plating exposed region 35a exposed on a surface of the first outer electrode 30a.

The second outer electrode 30b includes a second base electrode layer 32b including a metal component, a second lower plating layer 34b₁ disposed on the second base electrode layer 32b, and a second upper plating layer 34b₂ disposed on the second lower plating layer 34b₁. In addition, the second outer electrode 30b includes a second plating exposed region 35b exposed on a surface of the second outer electrode 30b.

### (2-1) Base Electrode Layer

The first base electrode layer 32a is connected to the first inner electrode layer 16a and is disposed on the surface of the first end surface 12e. In this case, the first base electrode layer 32a is electrically connected to the first extended electrode portion 28a of the first inner electrode layer 16a. In the present example embodiment, the first base electrode layer 32a extends from the first end surface 12e to a portion of the first main surface 12a, a portion of the second main surface 12b, a portion of the first side surface 12c, and a portion of the second side surface 12d.

The second base electrode layer 32b is connected to the second inner electrode layer 16b and is disposed on the surface of the second end surface 12f. In this case, the second base electrode layer 32b is electrically connected to the second extended electrode portion 28b of the second inner electrode layer 16b. In the present example embodiment, the second base electrode layer 32b extends from the second end surface 12f to a portion of the first main surface 12a, a portion of the second main surface 12b, a portion of the first side surface 12c, and a portion of the second side surface 12d.

The base electrode layer 32 includes at least one of a baked layer, a conductive resin layer, a thin film layer, or the like.

Hereinafter, a configuration of each of cases where the base electrode layer 32 is the above-described baked layer, conductive resin layer, and thin film layer will be described.

Case where Base Electrode Layer Includes Baked Layer

The baked layer includes a glass component and a metal component. The glass component of the baked layer includes, for example, at least one of B, Si, Ba, Mg, Al, Li, or the like. The metal component of the baked layer includes, for example, at least one of Cu, Ni, Ag, Pd, an Ag—Pd alloy, Au, or the like. The baked layer may include a plurality of layers. The baked layer is a layer obtained by applying a conductive paste including a glass component and a metal component to the multilayer body 12 and performing a baking treatment, and may be fired simultaneously with the inner electrode layer 16 and the ceramic layer 14, or may be fired after the inner electrode layer 16 and the ceramic layer 14 are baked. When the baked layer is fired simultaneously with the inner electrode layer 16 and the ceramic layer 14, it is preferable to add a ceramic component instead of the glass component to form the baked layer. As the ceramic component, the same kind of ceramic material as the ceramic layer 14 may be used, or a different kind of ceramic material may be used. The ceramic component includes, for example, at least one of BaTiO₃, CaTiO₃, (Ba,Ca)TiO₃, SrTiO₃, CaZrO₃, or the like. The baked layer includes the glass component or the ceramic component, such that the close-contact property between the multilayer body 12 and the base electrode layer 32 which is the baked layer can be improved. The baked layer may include both the glass component and the ceramic component.

Thicknesses of first and second baked layers in central portion in the height direction x of the first and second base electrode layers 32a and 32b located on the first end surface 12e and the second end surface 12f are, for example, preferably about 3 μm or more and about 20 μm or less.

In addition, when the base electrode layer 32 is provided on the first main surface 12a and the second main surface 12b and on the first side surface 12c and the second side surface 12d, thicknesses of first and second baked layers in central portions in the length direction z of the first and second base electrode layers 32a and 32b located on the first main surface 12a and the second main surface 12b and on the first side surface 12c and the second side surface 12d are, for example, preferably about 1 μm or more and about 20 μm or less.

Case where Base Electrode Layer Includes Conductive Resin Layer

The conductive resin layer may include a plurality of layers.

The conductive resin layer may be disposed on the baked layer to cover the baked layer, or the conductive resin layer may be directly disposed on the multilayer body 12.

Further, in the case where the conductive resin layer is disposed on the baked layer, the conductive resin layer is disposed to cover the base electrode layer 32 which is the baked layer. The conductive resin layer includes a first conductive resin layer and a second conductive resin layer. The first conductive resin layer is disposed to cover the first base electrode layer 32a, and the second conductive resin is disposed to cover the second base electrode layer 32b. Specifically, the first and second conductive resin layers are disposed on the first base electrode layer 32a and the second base electrode layer 32b which are located on the first end surface 12e and the second end surface 12f. Further, it is preferable that the first and second conductive resin layers extend to the first main surface 12a and the second main surface 12b, and the first side surface 12c and the second side surface 12d. Meanwhile, the first and second conductive resin layers may be disposed only on the first base electrode layer 32a and the second base electrode layer 32b which are located on the first end surface 12e and the second end surface 12f. When the outer electrode 30 includes the plating layer 34, the conductive resin layer can be disposed to be located between the base electrode layer 32 and the plating layer 34.

The conductive resin layer includes thermosetting resin and a metal.

Since the conductive resin layer includes a thermosetting resin, the conductive resin layer is more flexible than, for example, a conductive layer formed of a plating film or a fired product of a conductive paste. Therefore, even when a physical impact or an impact caused by a thermal cycle is applied to the two-terminal multilayer ceramic capacitor 10, the conductive resin layer defines and functions as a buffer layer, and it is possible to prevent cracks from occurring in the two-terminal multilayer ceramic capacitor 10.

As the metal included in the conductive resin layer, for example, Ag, Cu, Ni, Sn, Bi, or an alloy including these metals can be used.

In addition, a metal powder whose surface is coated with, for example, Ag can also be used. In a case of using a metal powder whose surface is coated with Ag, it is preferable to use, for example, Cu, Ni, Sn, Bi, or an alloy powder thereof as the metal powder. The reason for using the conductive metal powder of Ag for the conductive metal is that Ag is suitable for an electrode material because Ag has the lowest specific resistance among metals, and Ag does not oxidize and has high weather resistance because Ag is a noble metal. In addition, the reason for using the Ag-coated metal powder is that it is possible to make the metal of the base material inexpensive while maintaining the characteristics of Ag.

Further, as the metal included in the conductive resin layer, for example, Cu and Ni which have been subjected to an oxidation prevention treatment can also be used.

As the metal included in the conductive resin layer, for example, a metal powder whose surface is coated with Sn, Ni, and Cu can also be used. In a case of using a metal powder whose surface is coated with Sn, Ni, and Cu, it is preferable to use, for example, Ag, Cu, Ni, Sn, Bi, or an alloy powder thereof as the metal powder.

The metal included in the conductive resin layer is, for example, preferably included in an amount of about 35 vol % or more and about 75 vol % or less with respect to the volume of the entire conductive resin.

An average particle diameter of the metal included in the conductive resin layer is not particularly limited. An average particle diameter of a conductive filler may be, for example, about 0.3 μm or more and about 10 μm or less.

The metal included in the conductive resin layer is mainly responsible for the conductivity of the conductive resin layer. Specifically, the conductive fillers come into contact with each other to provide a current path inside the conductive resin layer.

A shape of the metal included in the conductive resin layer is not particularly limited, and a spherical shape, a flat shape, or the like can be used. As the metal included in the conductive resin layer, it is preferable to use a spherical metal powder and a flat metal powder mixed together.

As the resin of the conductive resin layer, for example, various known thermosetting resins such as an epoxy resin, a phenoxy resin, a phenol resin, a urethane resin, a silicone resin, and a polyimide resin can be used. Among these, an epoxy resin having excellent heat resistance, moisture resistance, close-contact property, and the like is one of the most suitable resins.

The resin included in the conductive resin layer is preferably included in an amount of, for example, about 25 vol % or more and about 65 vol % or less with respect to the volume of the entire conductive resin.

In addition, the conductive resin layer preferably includes a curing agent together with the thermosetting resin. When an epoxy resin is used as a base resin, various known compounds such as, for example, a phenol-based compound, an amine-based compound, an acid anhydride-based compound, an imidazole-based compound, an active ester-based compound, and an amide-imide-based compound can be used as the curing agent of the epoxy resin.

A thickness of the conductive resin layer located in a central portion in the height direction x of the multilayer body 12 located on the first end surface 12e and the second end surface 12f is, for example, preferably about 3 μm or more and about 30 μm or less.

In addition, when the conductive resin layer is also provided on the first main surface 12a and the second main surface 12b and on the first side surface 12c and the second side surface 12d, a thickness of a conductive resin layer in central portion in the length direction z of the conductive resin layer located on the first main surface 12a and the second main surface 12b and on the first side surface 12c and the second side surface 12d is, for example, preferably about 3 μm or more and about 30 μm or less.

Case where Base Electrode Layer Includes Thin Film Layer

The thin film layer is formed using a thin film forming method such as, for example, a sputtering method or a vapor deposition method, and is a layer of, for example, about 1 μm or less in which metal particles are deposited.

### (2-2) Plating Layer

Subsequently, a first plating layer 34a and a second plating layer 34b, which are the plating layers 34 disposed on the base electrode layer 32, will be described with reference to FIGS. 2 to 5. The plating layer 34 includes a plating exposed region 35.

The first plating layer 34a is disposed to cover the first base electrode layer 32a on the first end surface 12e side. Further, the first plating layer 34a may be disposed to cover the first base electrode layer 32a on the first main surface 12a side, the second main surface 12b side, the first side surface 12c side, and the second side surface 12d side. Meanwhile, the first plating layer 34a may be disposed only on the first base electrode layer 32a on the first end surface 12e side. The first plating layer 34a includes a first lower plating layer 34a₁ disposed on the first base electrode layer 32a, and a first upper plating layer 34a₂ disposed on the first lower plating layer 34a₁. The first upper plating layer 34a₂ is disposed on the first lower plating layer 34a₁ to expose a portion of the first lower plating layer 34a₁. That is, the first upper plating layer 34a₂ is disposed on the first lower plating layer 34a₁ except for the first plating exposed region 35a exposed on the surface of the first outer electrode 30a so that the first lower plating layer 34a₁ includes the first plating exposed region 35a.

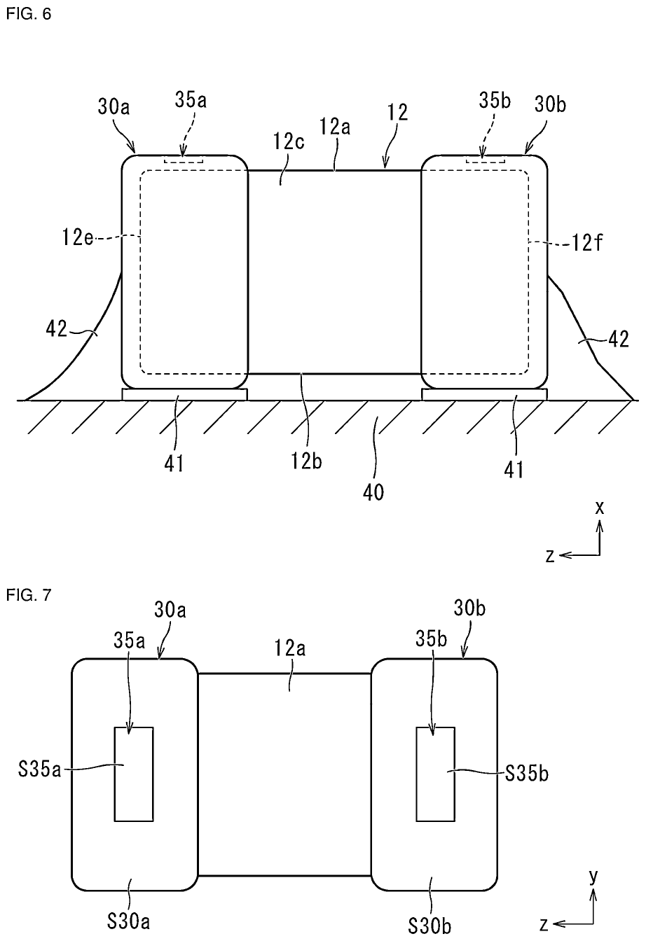

In the present example embodiment, the first plating exposed region 35a is disposed on the first main surface 12a. In this case, as shown in FIG. 6, the second main surface 12b of the two-terminal multilayer ceramic capacitor 10 becomes a mounting surface on a mounting substrate 40. FIG. 6 is a side view showing an example of the two-terminal multilayer ceramic capacitor mounted using solder. According to FIG. 6, a pair of lands 41 having a planar shape for mounting the two-terminal multilayer ceramic capacitor 10 is provided on the mounting substrate 40. The two-terminal multilayer ceramic capacitor 10 is disposed such that the second main surface 12b faces the mounting surface of the mounting substrate 40 and the first outer electrode 30a and the second outer electrode 30b are located on the pair of lands 41 in a state where the first main surface 12a is farthest from the mounting surface. In this state, the two-terminal multilayer ceramic capacitor 10 is mounted on the mounting substrate 40 by applying solder 42 to the first end surface 12e and the second end surface 12f.

Although not limited thereto, it is preferable that the first upper plating layer 34a₂ covers an end portion of the first lower plating layer 34a₁. Specifically, it is preferable that a tip portion of the first lower plating layer 34a₁ on the second end surface 12f side is covered with a tip portion of the first upper plating layer 34a₂ on the second end surface 12f side. As a result, peeling of the first lower plating layer 34a₁ can be reduced or prevented.

A first ratio of an area of the first plating exposed region 35a to an area of an exposed region of the first outer electrode 30a on the first main surface 12a of the multilayer body 12 when viewed in the height direction x is, for example, preferably about 0.4% or more and about 83.4% or less. Since the first ratio is about 0.4% or more, for example, hydrogen released from the first and second inner electrode layers 16a and 16b, the first and second base electrode layers 32a and 32b, and the first and second lower plating layers 34a₁ and 34b₁ can be sufficiently emitted from the first plating exposed region 35a to the outside of the two-terminal multilayer ceramic capacitor 10, and the deterioration of the insulation resistance due to hydrogen can be reduced or prevented. In addition, since the first ratio is about 83.4% or less, a ratio of the first lower plating layer 34a₁ that is not covered with the first upper plating layer 34a₂ can be reduced or prevented. As a result, it is possible to reduce or prevent a decrease in the moisture resistance due to water vapor intrusion into the two-terminal multilayer ceramic capacitor 10 from the first plating exposed region 35a.

The first ratio is, for example, more preferably about 1.17% or more and about 83.4% or less. The first ratio is, for example, even more preferably about 1.40% or more and about 83.4% or less. The first ratio is, for example, even more preferably about 1.40% or more and about 25.0% or less.

The first ratio can be obtained as follows, as a first example. First, the area of the exposed region of the first outer electrode 30a can be obtained from an area of a region where the first outer electrode 30a faces an outer side portion of the two-terminal multilayer ceramic capacitor 10. For example, the area of the exposed region of the first outer electrode 30a can be obtained from an area of a region where the first outer electrode 30a faces the outer side portion of the two-terminal multilayer ceramic capacitor 10 on the first main surface 12a, the second main surface 12b, the first end surface 12e, the first side surface 12c, and the second side surface 12d. In addition, the area of the first plating exposed region 35a can be obtained from an area of a region where the first lower plating layer 34a₁ faces the outer side portion of the two-terminal multilayer ceramic capacitor 10. For example, the area of the first plating exposed region 35a can be obtained from an area of a region where the first lower plating layer 34a₁ faces the outer side portion of the two-terminal multilayer ceramic capacitor 10 on the first main surface 12a, the second main surface 12b, the second end surface 12f, the first side surface 12c, and the second side surface 12d. Then, the first ratio can be obtained from the ratio of the area of the first plating exposed region 35a to the area of the exposed region of the first outer electrode 30a.

In the case of the first example, in the present example embodiment, as shown in FIG. 7, an area S30a of the exposed region of the first outer electrode 30a can be obtained from a region where the first outer electrode 30a (the first base electrode layer 32a, the first lower plating layer 34a₁, and the first upper plating layer 34a₂) faces the outer side portion of the two-terminal multilayer ceramic capacitor 10 on the first main surface 12a, when viewed from the first main surface 12a side (when viewed in a direction of the first main surface). In addition, in the present example embodiment, an area S35a of the first plating exposed region 35a can be obtained from a region where the first lower plating layer 34a₁ faces the outer side portion of the two-terminal multilayer ceramic capacitor 10 on all surfaces of the first main surface 12a, the second main surface 12b, the first end surface 12e, the first side surface 12c, and the second side surface 12d. In FIG. 7, an aspect in which the first plating exposed region 35a is on the first main surface 12a side is shown as an example. Then, the first ratio can be obtained from a ratio of the area S35a of the first plating exposed region 35a to the area S30a of the exposed region of the first outer electrode 30a. The area S30a and the area S35a can be observed, for example, using a microscope (for example, VHX series (hereinafter, VHX) manufactured by KEYENCE CORPORATION) at a magnification of about 200× and in a bright field.

In addition, the first ratio can be obtained as follows, as a second example. The area of the exposed region of the first outer electrode 30a is obtained in the same or substantially the same manner as in the first example. In addition, in addition to the first upper plating layer 34a₂, the first lower plating layer 34a₁ is also scraped, so that when the first plating exposed region 35a intersects the first main surface 12a, the second main surface 12b, the first end surface 12e, the first side surface 12c, or the second side surface 12d, the area of the first plating exposed region 35a can be obtained by multiplying a thickness of the exposed first lower plating layer 34a₁ and a length of a periphery of the first plating exposed region 35a. Then, the first ratio can be obtained from the ratio of the area of the first plating exposed region 35a to the area of the exposed region of the first outer electrode 30a.

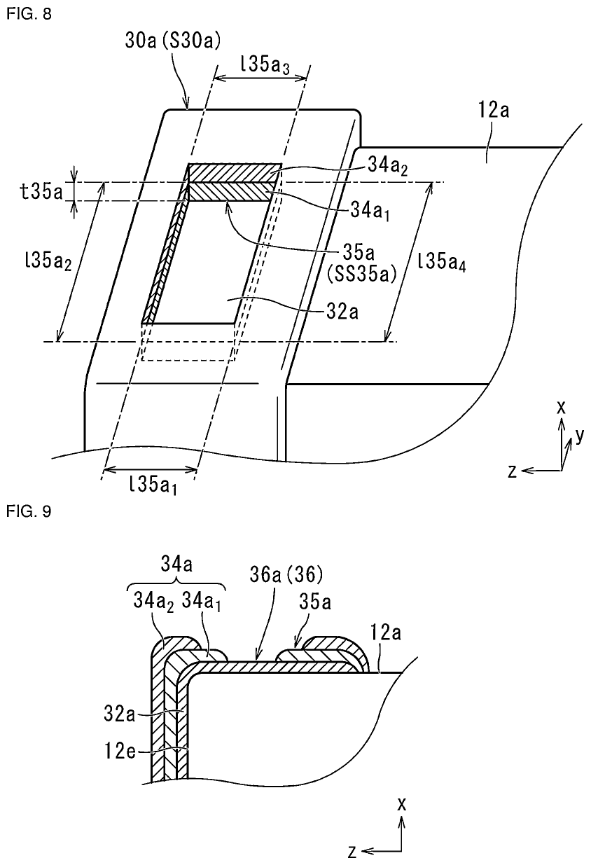

In the case of the second example, in the present example embodiment, as in FIG. 7, an area S30a of the exposed region of the first outer electrode 30a can be obtained from a region where the first outer electrode 30a faces the outer side portion of the two-terminal multilayer ceramic capacitor 10 on the first main surface 12a, when viewed from the first main surface 12a side (when viewed in a direction of the first main surface). In addition, when the first plating exposed region 35a intersects the first main surface 12a, the second main surface 12b, the first end surface 12e, the first side surface 12c, or the second side surface 12d, an area SS35a of the first plating exposed region 35a can be obtained by multiplying a thickness t35a of the exposed first lower plating layer 34a₁ and a length (sum of 135a₁, 135a₂, 135a₃, and 135a₄) of a periphery of the first plating exposed region 35a. In FIG. 8, an aspect in which the first plating exposed region 35a intersects the first main surface 12a is shown as an example. Then, the first ratio can be obtained from a ratio of the area SS35a of the first plating exposed region 35a to the area S30a of the exposed region of the first outer electrode 30a. The lengths 135a₁ to 135a₄ can be observed, for example, using a microscope (VHX) at a magnification of about 200× and in a bright field. In addition, the thickness t35a can be observed, for example, using a microscope (VHX) at a magnification of about 2000× and in a bright field after a cross section is polished up to, for example, about a ½ dimension of a W dimension in the width direction y of the two-terminal multilayer ceramic capacitor 10.

The second plating layer 34b is disposed to cover the second base electrode layer 32b on the second end surface 12f side. Further, the second plating layer 34b may be disposed to cover the second base electrode layer 32b on the first main surface 12a side, the second main surface 12b side, the first side surface 12c side, and the second side surface 12d side. Meanwhile, the second plating layer 34b may be disposed only on the second base electrode layer 32b on the second end surface 12f side. The second plating layer 34b includes a second lower plating layer 34b₁ disposed on the second base electrode layer 32b, and a second upper plating layer 34b₂ disposed on the second lower plating layer 34b₁. The second upper plating layer 34b₂ is disposed on the second lower plating layer 34b₁ to expose a portion of the second lower plating layer 34b₁. That is, the second upper plating layer 34b₂ is disposed on the second lower plating layer 34b₁ except for the second plating exposed region 35b exposed on the surface of the second outer electrode 30b so that the second lower plating layer 34b₁ has the second plating exposed region 35b. In the present example embodiment, the second plating exposed region 35b is disposed on the first main surface 12a. In this case, the second main surface 12b of the two-terminal multilayer ceramic capacitor 10 becomes the mounting surface on the mounting substrate.

Although not limited thereto, it is preferable that the second upper plating layer 34b₂ covers an end portion of the second lower plating layer 34b₁. Specifically, it is preferable that a tip portion of the second lower plating layer 34b₁ on the first end surface 12e side is covered with a tip portion of the second upper plating layer 34b₂ on the first end surface 12e side. As a result, peeling of the second lower plating layer 34b₁ can be reduced or prevented.

For the same or substantially the same reason as the first ratio, a second ratio of an area of the second plating exposed region 35b to an area of an exposed region of the second outer electrode 30b on the first main surface 12a of the multilayer body 12 when viewed in the height direction x is, for example, preferably about 0.4% or more and about 83.4% or less. Since the second ratio is about 0.4% or more, for example, hydrogen released from the first and second inner electrode layers 16a and 16b, the first and second base electrode layers 32a and 32b, and the first and second lower plating layers 34a₁ and 34b₁ can be sufficiently emitted from the second plating exposed region 35b to the outside of the two-terminal multilayer ceramic capacitor 10, and the deterioration of the insulation resistance due to hydrogen can be reduced or prevented. In addition, since the second ratio is about 83.4% or less, it is possible to reduce or prevent a decrease in the moisture resistance due to water vapor intrusion into the two-terminal multilayer ceramic capacitor 10 from the second plating exposed region 35b.

The second ratio is, for example, more preferably about 1.17% or more and about 83.4% or less. The second ratio is, for example, even more preferably about 1.40% or more and about 83.4% or less. The second ratio is, for example, even more preferably about 1.40% or more and about 25.0% or less.

The second ratio can be obtained in the same or substantially the same manner as the first ratio. In the case of the first example, in the present example embodiment, the area of the exposed region of the second outer electrode 30b can be obtained from an area of a region where the second outer electrode 30b (the second base electrode layer 32b, the second lower plating layer 34b₁, and the second upper plating layer 34b₂) faces the outer side portion of the two-terminal multilayer ceramic capacitor 10 on the first main surface 12a, when viewed from the first main surface 12a side. In addition, in the present example embodiment, the area of the second plating exposed region 35b can be obtained from an area of a region where the second lower plating layer 34b₁ faces the outer side portion of the two-terminal multilayer ceramic capacitor 10 when viewed from all surfaces of the first main surface 12a, the second main surface 12b, the second end surface 12f, the first side surface 12c, and the second side surface 12d.

Further, in the case of the second example, in the present example embodiment, the area of the exposed region of the second outer electrode 30b can be obtained in the same or substantially the same manner as in the first example. In addition, in the present example embodiment, when the second plating exposed region 35b intersects the first main surface 12a, the second main surface 12b, the second end surface 12f, the first side surface 12c, or the second side surface 12d, the area of the second plating exposed region 35b can be obtained from an area obtained by multiplying a thickness t35a of the exposed second lower plating layer 34b₁ and a length of a periphery of the second plating exposed region 35b.

Then, the second ratio can be obtained from the ratio of the area of the second plating exposed region 35b to the area of the exposed region of the second outer electrode 30b.

In the above, the first ratio and the second ratio are obtained as the exposure ratio, but the exposure ratio may be a ratio of the total area of the first plating exposed region 35a and the second plating exposed region 35b to the total area of the exposed regions of the first outer electrode 30a and the second outer electrode 30b. Then, the total exposure ratio is, for example, preferably about 0.4% or more and about 83.4% or less.

The first plating layer 34a and the second plating layer 34b include, for example, at least one of Cu, Ni, Sn, Ag, Pd, an Ag—Pd alloy, Au, or the like.

For example, it is preferable that the first lower plating layer 34a₁ and the second lower plating layer 34b₁ are Ni plating layers and the first upper plating layer 34a₂ and the second upper plating layer 34b₂ are Sn plating layers.

The first and second lower plating layers 34a₁ and 34b₁ made of the Ni plating layer are used to prevent the base electrode layer 32 from being corroded by solder when the two-terminal multilayer ceramic capacitor 10 is mounted. In addition, the first and second upper plating layers 34a₂ and 34b₂ made of the Sn plating layer are used to improve the wettability of solder when the two-terminal multilayer ceramic capacitor 10 is mounted, and to facilitate mounting.

Thicknesses of the first lower plating layer 34a₁ and the first upper plating layer 34a₂ on the first main surface 12a, the second main surface 12b, the first end surface 12e, the first side surface 12c, and the second side surface 12d are, for example, preferably about 2 μm or more and about 7 μm or less. Thicknesses of the second lower plating layer 34b₁ and the second upper plating layer 34b₂ on the first main surface 12a, the second main surface 12b, the second end surface 12f, the first side surface 12c, and the second side surface 12d are, for example, preferably about 2 μm or more and about 7 μm or less.

When the conductive resin layer is provided on the base electrode layer 32, the plating layer 34 is disposed to cover the conductive resin layer. Even in this case, the Ni plating layer, which is the lower plating layer, of the plating layer 34 prevents the conductive resin layer from being eroded by the solder, and the Sn plating layer, which is the upper plating layer, improves the wettability of the solder.

### (3) Dimensions of Two-Terminal Multilayer Ceramic Capacitor

A dimension in the length direction z of the two-terminal multilayer ceramic capacitor 10 including the multilayer body 12, the first outer electrode 30a, and the second outer electrode 30b is defined as an L dimension, a dimension in the height direction x of the two-terminal multilayer ceramic capacitor 10 including the multilayer body 12, the first outer electrode 30a, and the second outer electrode 30b is defined as a T dimension, and a dimension in the width direction y of the two-terminal multilayer ceramic capacitor 10 including the multilayer body 12, the first outer electrode 30a, and the second outer electrode 30b is defined as a W dimension.

The dimensions of the two-terminal multilayer ceramic capacitor 10 are, for example, as follows: the L dimension in the length direction z is about 0.2 mm or more and about 6.5 mm or less, the W dimension in the width direction y is about 0.1 mm or more and about 5.5 mm or less, and the T dimension in the height direction x is about 0.1 mm or more and about 6.5 mm or less. In addition, the dimensions of the two-terminal multilayer ceramic capacitor 10 can be measured with a microscope.

### 2. Method of Manufacturing Two-Terminal Multilayer Ceramic Capacitor

Next, an example of a method of manufacturing the two-terminal multilayer ceramic capacitor 10 will be described.

(Step 1) First, a dielectric sheet for the ceramic layer 14 and a conductive paste for the inner electrode layer 16 are prepared. The dielectric sheet and the conductive paste for the inner electrode layer 16 include a binder and a solvent. The binder and the solvent may be known ones.

(Step 2) Then, the conductive paste for the inner electrode layer 16 is applied on the dielectric sheet in a predetermined pattern through, for example, screen printing or gravure printing. As a result, a dielectric sheet on which a pattern of the first inner electrode layer 16a is formed and a dielectric sheet on which a pattern of the second inner electrode layer 16b is formed are prepared.

In addition, regarding the dielectric sheet, a dielectric sheet for an outer layer in which the pattern of the inner electrode layer is not printed is also prepared.

(Step 3) A predetermined number of the dielectric sheets for the outer layer on which the pattern of the inner electrode layer is not printed are stacked, thereby forming the outer layer portion 14a on the second main surface 12b side (outer layer portion forming step).

The dielectric sheet on which the pattern of the first inner electrode layer 16a is printed and the dielectric sheet on which the pattern of the second inner electrode layer 16b is printed are sequentially stacked on the outer layer portion 14a on the second main surface 12b side to have the structure of an example embodiment of the present invention, thus forming the inner layer portion 14b (inner layer portion forming step).

Subsequently, a predetermined number of the dielectric sheets for the outer layer on which the pattern of the inner electrode layer is not printed are stacked on the inner layer portion. Accordingly, the outer layer portion 14a on the first main surface 12a side is formed on the inner layer portion 14b (outer layer portion forming step).

(Step 4) Next, the stacked sheet is pressed in the stacking direction by, for example, an isostatic press, thus producing a stacked block.

(Step 5) Then, the stacked block is cut to have a predetermined size, and thus a stacked chip is cut out. In this case, a corner portion and a ridge portion of the stacked chip may be rounded through, for example, barrel polishing or the like.

(Step 6) Next, the multilayer body 12 is produced by firing the stacked chip. A firing temperature is determined depending on the material of the ceramic layer or the inner electrode layer, which is a dielectric, and is, for example, preferably about 900° C. or higher and about 1400° C. or lower.

(Step 7) Next, the base electrode layer 32 is formed by applying a conductive paste for an outer electrode to both end surfaces 12e and 12f of the multilayer body 12. A manufacturing process will be described below for each of the cases where the base electrode layer 32 is a baked layer, a conductive resin layer, and a thin film layer.

Case where Base Electrode Layer is Baked Layer

In a case where the base electrode layer 32 is a baked layer, a conductive paste including a glass component and a metal is applied using a method such as, for example, dipping and screen printing, and then a baking treatment is performed to form the base electrode layer 32. The baking temperature at this time is, for example, preferably about 700° C. or higher and about 900° C. or lower.

The baked layer may include a ceramic component instead of the glass component, or may contain both. The ceramic component is preferably, for example, a ceramic material of the same kind as the multilayer body. When the baked layer includes the ceramic component, it is preferable to form a multilayer body in which the baked layer is formed by applying a conductive paste to the stacked chip before firing and simultaneously baking (firing) the stacked chip before firing and the conductive paste applied to the stacked chip before firing. A temperature (firing temperature) of the baking treatment at this time is, for example, preferably about 900° C. or higher and about 1400° C. or lower.

Case where Base Electrode Layer is Conductive Resin Layer

In a case where the base electrode layer 32 is a conductive resin layer, a conductive resin paste including a thermosetting resin and a metal component is applied onto the baked layer or the multilayer body 12, and a heat treatment is performed at a temperature of, for example, about 250° C. or higher and about 550° C. or lower to thermally cure the resin and form the conductive resin layer. The atmosphere during the heat treatment at this time is, for example, preferably N2 atmosphere. In addition, in order to prevent scattering of the resin and to prevent oxidation of various metal components, an oxygen concentration is, for example, preferably reduced to about 100 ppm or less.

Case where Base Electrode Layer is Thin Film Layer

In a case where the base electrode layer 32 is a thin film layer, the base electrode layer 32 can be formed using a thin film forming method such as, for example, a sputtering method or a vapor deposition method. The base electrode layer 32 formed of the thin film layer is a layer of, for example, about 1 μm or less in which metal particles are deposited.

(Step 8) After the base electrode layer 32 is formed, the plating layer 34 is formed on a surface of the base electrode layer 32. In performing a plating treatment, for example, either electrolytic plating or electroless plating may be adopted, but the electroless plating requires a pretreatment with a catalyst or the like in order to improve a plating deposition rate, which is a disadvantage in that the process becomes complicated. Therefore, it is preferable to use the electrolytic plating in general. As the plating method, barrel plating is preferably used. In the present example embodiment, as the plating layer 34, the first lower plating layer 34a₁ and the second lower plating layer 34b₁ (Ni plating layers) and the first upper plating layer 34a₂ and the second upper plating layer 34b₂ (Sn plating layers) are sequentially formed on the base electrode layer 32.

When the conductive resin layer is formed on the base electrode layer 32, a conductive resin paste including a resin component and a metal component is prepared, and the conductive resin paste is applied onto the base electrode layer 32 using a dipping method. Thereafter, the plating layer 34 is formed on the conductive resin layer.

(Step 9) Next, the first upper plating layer 34a₂ and the second upper plating layer 34b₂ (Sn plating layers) are treated such that the first lower plating layer 34a₁ and the second lower plating layer 34b₁ (Ni plating layers) have a predetermined exposure ratio. As the treatment method, for example, a scraping method, a melting method, a method of laser processing, or a method of using a resist can be adopted.

In the scraping method, a soft Sn plating layer is scraped by bringing a metal terminal having a size of, for example, about φ30 to about 100 μm into contact with the first upper plating layer 34a₂ and the second upper plating layer 34b₂ (Sn plating layers) so that the first lower plating layer 34a₁ and the second lower plating layer 34b₁ (Ni plating layers) have a predetermined exposure ratio.

In the melting method, a formed body after the plating layer 34 is formed is immersed in an ENSTRIP agent (release agent). For example, heights of a plurality of the formed bodies after the plating layer 34 is formed are aligned with an alignment jig, and one surface of the formed bodies is immersed in the ENSTRIP agent to dissolve the first upper plating layer 34a₂ and the second upper plating layer 34b₂ (Sn plating layers) so that the first lower plating layer 34a₁ and the second lower plating layer 34b₁ (Ni plating layers) have a predetermined exposure ratio. At this time, it is preferable to immerse the first main surface 12a (and/or the second main surface 12b) side. As a result, it is possible to prevent the first end surface 12e side, the second end surface 12f side, the first side surface 12c side, and the second side surface 12d side from being immersed in the inner electrode layer 16.

In the method of laser processing, a plurality of the formed bodies after the plating layer 34 is formed are aligned, and predetermined areas of the first upper plating layer 34a₂ and the second upper plating layer 34b₂ (Sn plating layers) of each formed body are scraped by a laser so that the first lower plating layer 34a₁ and the second lower plating layer 34b₁ (Ni plating layers) have a predetermined exposure ratio.

Even when a resist is used, the first and second lower plating layers 34a₁ and 34b₁ (Ni plating layers) having a predetermined exposure ratio can be formed.

As described above, the two-terminal multilayer ceramic capacitor 10 according to the present example embodiment is manufactured.

Since the first lower plating layer 34a₁ is exposed on the surface of the first outer electrode 30a in the first plating exposed region 35a, hydrogen in the two-terminal multilayer ceramic capacitor 10 can be released from the first plating exposed region 35a to the outside of the two-terminal multilayer ceramic capacitor 10. Similarly, since the second lower plating layer 34b₁ is exposed on the surface of the second outer electrode 30b in the second plating exposed region 35b, hydrogen in the two-terminal multilayer ceramic capacitor 10 can be released from the second plating exposed region 35b to the outside of the two-terminal multilayer ceramic capacitor 10. Further, the description is as follows.

In the plating step of forming the first and second lower plating layers 34a₁ and 34b₁ and the first and second upper plating layers 34a₂ and 34b₂, hydrogen ions are generated by a chemical reaction. These hydrogen ions may be absorbed as hydrogen into, for example, at least any of the first and second lower plating layers 34a₁ and 34b₁, the first and second inner electrode layers 16a and 16b, and the first and second base electrode layers 32a and 32b. With the above configuration, hydrogen absorbed into at least any layer (absorption layer) of the first and second lower plating layers 34a₁ and 34b₁, the first and second inner electrode layers 16a and 16b, and the first and second base electrode layers 32a and 32b can be released from the first and second plating exposed regions 35a and 35b to the outside of the two-terminal multilayer ceramic capacitor 10. Therefore, the hydrogen can be prevented from remaining absorbed into the absorption layer, and deterioration of insulation resistance due to the hydrogen can be reduced or prevented. In particular, even when the absorption layer includes a metal such as Ni that is difficult to absorb hydrogen, the deterioration of the insulation resistance of the ceramic layer 14 can be reduced or prevented by releasing the hydrogen to the outside of the two-terminal multilayer ceramic capacitor 10 from the first and second plating exposed regions 35a and 35b.

When the first and second plating exposed regions 35a and 35b are formed on the first main surface 12a side, the second main surface 12b side becomes the mounting surface of the two-terminal multilayer ceramic capacitor 10 on the mounting substrate, and solder is mainly applied to the first and second end surface 12e and 12f sides, the hydrogen of the absorption layer can be efficiently released from the first main surface 12a that is not applied with the solder and does not face the mounting substrate 40 through the first and second plating exposed regions 35a and 35b.

### 3. Modified Example of Two-Terminal Multilayer Ceramic Capacitor

Next, a modified example of the two-terminal multilayer ceramic capacitor 10 will be described.

The outer electrode 30 of the first example embodiment includes the base electrode layer 32 and the plating layer 34. In contrast, the outer electrode 30 may include the plating layer 34 and does not include the base electrode layer 32 in some cases.

Hereinafter, although not shown, a structure in which the plating layer 34 is provided without providing the base electrode layer 32 for the first and second outer electrodes 30a and 30b will be described.

Each of the first and second outer electrodes 30a and 30b is not provided with the base electrode layer 32 in some cases, and the plating layer 34 may be directly provided on the surface of the multilayer body 12. That is, the two-terminal multilayer ceramic capacitor 10 may have a structure in which the first end surface 12e and the second end surface 12f are subjected to a plating treatment and the plating layer 34 electrically connected to the first inner electrode layer 16a or the second inner electrode layer 16b is formed. In such a case, the plating layer 34 may be formed by the plating treatment after a catalyst is disposed on the surface of the multilayer body 12 as a pretreatment. In performing the plating treatment, either electrolytic plating or electroless plating may be used, for example. The electroless plating requires a pretreatment with a catalyst or the like in order to improve a plating deposition rate, which is a disadvantage in that the process becomes complicated. Therefore, it is preferable to use the electrolytic plating in general. As the plating method, barrel plating is preferably used.

When the plating layer 34 is directly formed on the multilayer body 12 without providing the base electrode layer 32, a reduced thickness of the base electrode layer 32 can be converted into a reduced height, that is, a thinner decrease, or a thickness of the multilayer body, that is, a thickness of the effective layer portion, so that the design freedom of the thickness of the multilayer body 12 can be improved.

The plating layer 34 includes first and second lower plating layers 34a₁ and 34b₁ (lower plating layers) formed on the surface of the multilayer body 12 and first and second upper plating layers 34a₂ and 34b₂ (upper plating layers) formed on the surfaces of the first and second lower plating layers 34a₁ and 34b₁. The lower plating layer has a plating exposed region that is not covered with the upper plating layer, as in the above-described example embodiment. It is preferable that the lower plating layer and the upper plating layer each include, for example, at least one metal selected from Cu, Ni, Sn, Pb, Au, Ag, Pd, Bi, and Zn, or an alloy including the metal.

Further, the lower plating layer is, for example, preferably made of Ni having solder barrier performance, and the upper plating layer is, for example, preferably made of Sn or Au having good solder wettability.

In addition, for example, when the first inner electrode layer 16a and the second inner electrode layer 16b are made of Ni, the lower plating layer is preferably made of Cu having good bondability with Ni. For the plating layer 34, the upper plating layer may be used as the outermost layer, or another plating electrode may be further provided on the surface of the upper plating layer.

Here, when the outer electrode 30 includes only the plating layer 34 without providing the base electrode layer 32, a thickness of the plating layer 34 disposed without providing the base electrode layer 32 is, for example, preferably about 1.0 μm or more and about 20.0 μm or less per layer.

Further, it is preferable that the plating layer 34 does not include glass. A metal ratio per unit volume of the plating layer 34 is, for example, preferably about 99% by volume or more.

In the first example embodiment described above, the first lower plating layer 34a₁ includes the first plating exposed region 35a that is not covered with the first upper plating layer 34a₂, and the second lower plating layer 34b₁ includes the second plating exposed region 35b that is not covered with the second upper plating layer 34b₂. However, the exposed region is not limited to this, and the outer electrode 30 may include a base exposed region 36 in which the base electrode layer 32 is not covered with the plating layer 34.

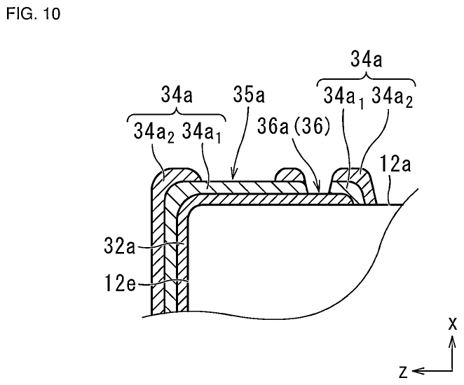

Specifically, the first base electrode layer 32a includes a first base exposed region 36a that is not covered with the first plating layer 34a. Such a first base exposed region 36a can be provided, for example, in the configuration of FIGS. 9 and 10. In FIG. 9, the first plating exposed region 35a is provided such that the first main surface 12a side of the first lower plating layer 34a₁ is exposed, and the first base exposed region 36a is provided in the first plating exposed region 35a. In the first base exposed region 36a, the first main surface 12a side of the first base electrode layer 32a is not covered with the first lower plating layer 34a₁ and the first upper plating layer 34a₂, and is exposed. In addition, in FIG. 10, on the first main surface 12a, the first plating exposed region 35a and the first base exposed region 36a are disposed at different positions.

As shown in FIGS. 9 and 10, it is preferable that the first base exposed region 36a is disposed on the first main surface 12a. It is preferable that the second main surface 12b is a mounting surface. As a result, when solder is mainly applied to the first and second end surfaces 12e and 12f as shown in FIG. 6, the hydrogen of the absorption layer can be efficiently released from the first main surface 12a that is not applied with the solder and does not face the mounting substrate 40 through the first base exposed region 36a.

The first base exposed region 36a may be disposed on any of the second main surface 12b, the first end surface 12e, the first side surface 12c, and the second side surface 12d other than the first main surface 12a, as long as the solder is not applied.

In addition, the first plating exposed region 35a and the first base exposed region 36a may be provided on different surfaces. For example, the first plating exposed region 35a may be disposed on the first end surface 12e, and the first base exposed region 36a may be disposed on the first main surface 12a.

In addition, it is preferable that the first base exposed region 36a is provided on the first end surface 12e side with respect to a tip portion of the first lower plating layer 34a₁ on the second end surface 12f side. That is, it is preferable that a tip portion of the first base electrode layer 32a on the second end surface 12f side is covered with the tip portion of the first lower plating layer 34a₁ on the second end surface 12f side. As a result, peeling of the first base electrode layer 32a can be reduced or prevented.

The first base exposed region 36a can be formed by, for example, removing the first lower plating layer 34a₁ and the first upper plating layer 34a₂ by a scraping method, a melting method, a method of laser processing, a method of using a resist, or the like, as with the first plating exposed region 35a.

Although not shown, the second base electrode layer 32b can also include a second base exposed region that is not covered with the second plating layer 34b.

In the first example embodiment described above, the first plating exposed region 35a in which the first lower plating layer 34a₁ is not covered with the first upper plating layer 34a₂ is provided on the first main surface 12a. Similarly, the second plating exposed region 35b in which the second lower plating layer 34b₁ is not covered with the second upper plating layer 34b₂ is provided on the first main surface 12a. The present invention is not limited thereto, and the plating exposed region 35 need only be provided on at least any of the first main surface 12a, the second main surface 12b, the first end surface 12e, the second end surface 12f, the first side surface 12c, and the second side surface 12d.

In the first example embodiment described above, the first plating exposed region 35a of the first outer electrode 30a and the second plating exposed region 35b of the second outer electrode 30b are provided. However, at least one of the first plating exposed region 35a and the second plating exposed region 35b need only be provided.

In the first example embodiment described above, the first lower plating layer 34a₁ is disposed to cover the entire or substantially the entire first base electrode layer 32a, and the second lower plating layer 34b₁ is disposed to cover the entire or substantially the entire second base electrode layer 32b. However, the present invention is not limited thereto, the first lower plating layer 34a₁ may be disposed to cover a portion of the first base electrode layer 32a, and the second lower plating layer 34b₁ may be disposed to cover a portion of the second base electrode layer 32b.

### B. Second Example Embodiment

### 1. Three-Terminal Multilayer Ceramic Capacitor

As an example of a multilayer ceramic electronic component according to a second example embodiment of the present invention, a three-terminal multilayer ceramic capacitor will be described.

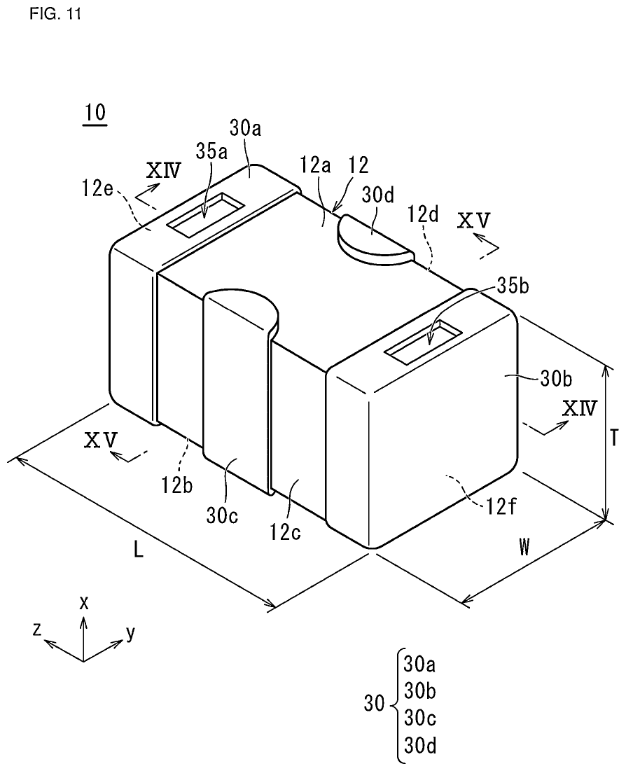

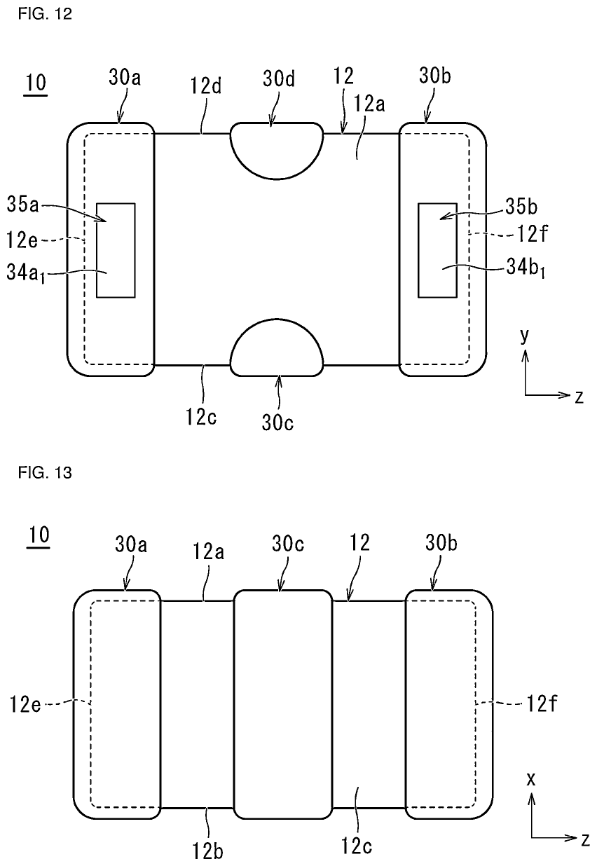

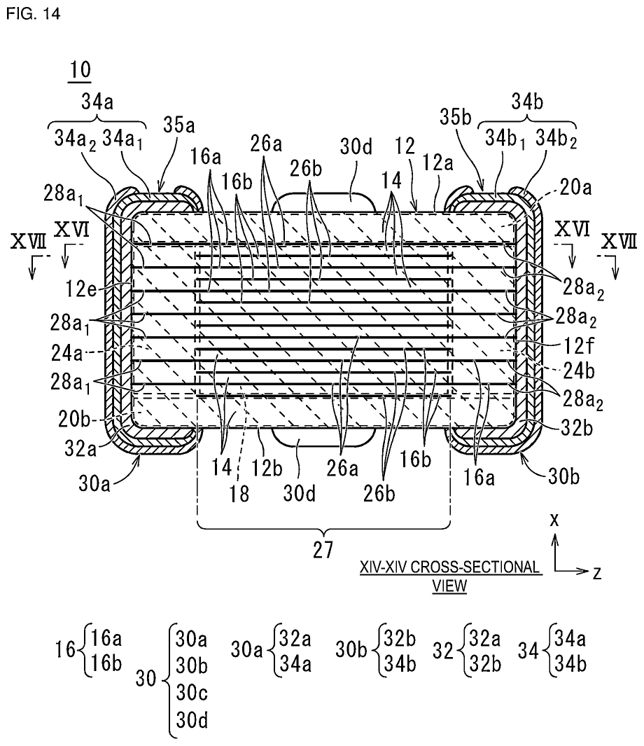

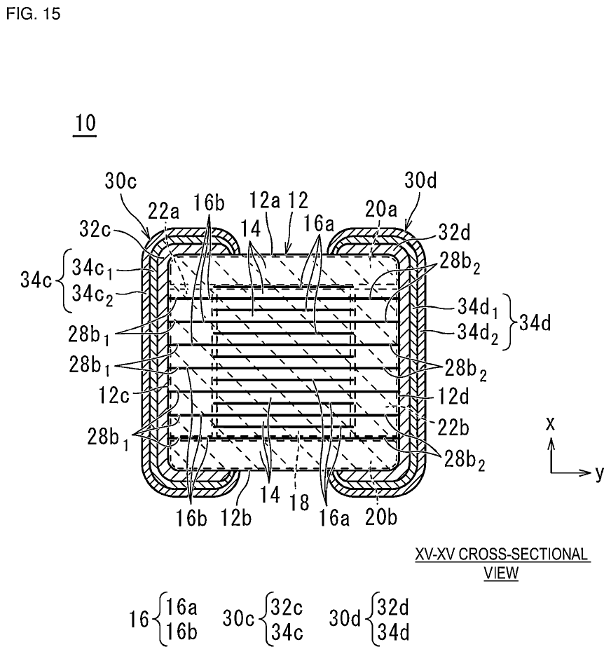

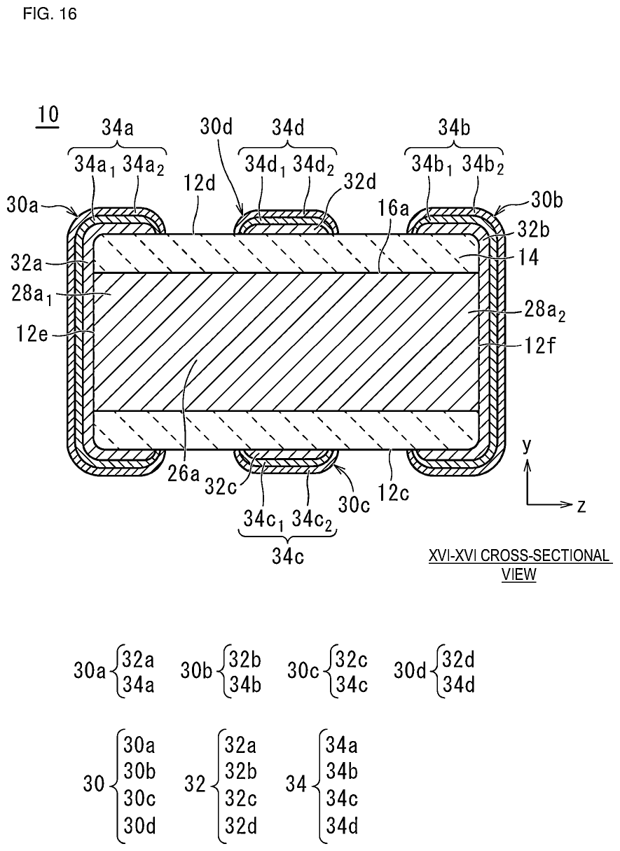

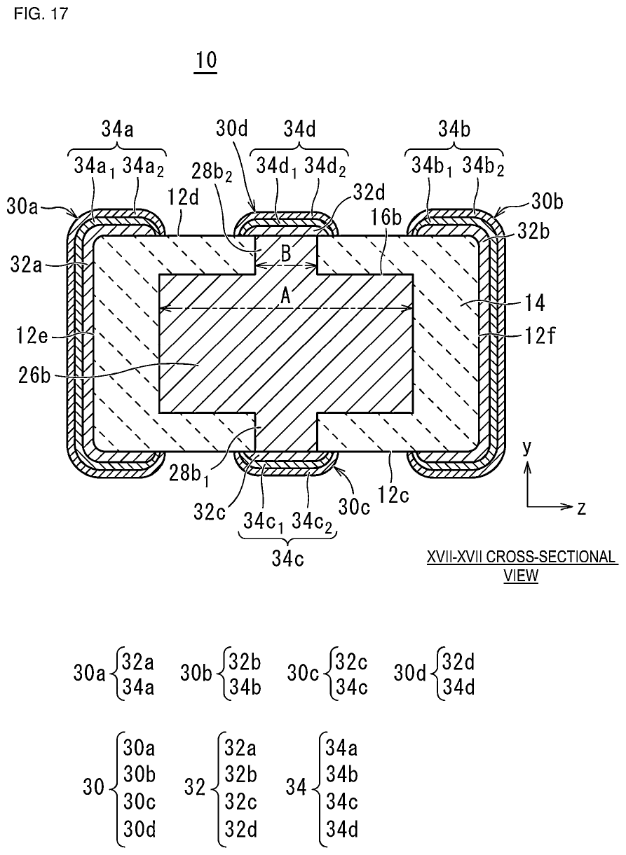

FIG. 11 is an external perspective view showing an example of the three-terminal multilayer ceramic capacitor according to the second example embodiment of the present invention. FIG. 12 is a top view showing the example of the three-terminal multilayer ceramic capacitor according to the second example embodiment of the present invention. FIG. 13 is a front view showing the example of the three-terminal multilayer ceramic capacitor according to the second example embodiment of the present invention. FIG. 14 is a cross-sectional view taken along a line XIV-XIV in FIG. 11. FIG. 15 is a cross-sectional view taken along a line XV-XV in FIG. 11. FIG. 16 is a cross-sectional view taken along a line XVI-XVI in FIG. 14. FIG. 17 is a cross-sectional view taken along a line XVII-XVII in FIG. 14.

As shown in FIG. 11, a three-terminal multilayer ceramic capacitor 100 includes, for example, a rectangular or substantially rectangular parallelepiped multilayer body 12 and an outer electrode 30.

### (1) Multilayer Body

The multilayer body 12 includes a plurality of stacked ceramic layers 14 and a plurality of inner electrode layers 16 stacked on the ceramic layers 14. The ceramic layers 14 and the inner electrode layers 16 are stacked in the height direction x.

The multilayer body 12 includes a first main surface 12a and a second main surface 12b facing each other in the height direction x, a first side surface 12c and a second side surface 12d facing each other in the width direction y orthogonal or substantially orthogonal to the height direction x, and a first end surface 12e and a second end surface 12f facing to each other in the length direction z orthogonal or substantially orthogonal to the height direction x and the width direction y. The multilayer body 12 includes rounded corner portions and ridge portions. The corner portion is a portion where three adjacent surfaces of the multilayer body intersect with each other, and the ridge portion is a portion where two adjacent surfaces of the multilayer body intersect with each other. In addition, unevenness or the like may be provided on a portion or all of the first main surface 12a and the second main surface 12b, the first side surface 12c and the second side surface 12d, and the first end surface 12e and the second end surface 12f.

The dimension L of the multilayer body 12 in the length direction z is not necessarily longer than the dimension W in the width direction y.

The multilayer body 12 includes an inner layer portion 18, and a first main surface-side outer layer portion 20a and a second main surface-side outer layer portion 20b that are disposed to sandwich the inner layer portion 18 therebetween in the stacking direction.

The inner layer portion 18 includes a plurality of ceramic layers 14 and a plurality of inner electrode layers 16. The inner layer portion 18 includes a region from the inner electrode layer 16 located closest to the first main surface 12a side to the inner electrode layer 16 located closest to the second main surface 12b side in the stacking direction. The inner electrode layer 16 includes a first inner electrode layer 16a extended to the first end surface 12e and the second end surface 12f and a second inner electrode layer 16b extended to the first side surface 12c and the second side surface 12d. In the inner layer portion 18, a plurality of the first inner electrode layers 16a and a plurality of the second inner electrode layers 16b face each other with the ceramic layer 14 interposed therebetween. The inner layer portion 18 is a portion that generates an electrostatic capacitance and substantially defines and functions as a capacitor.

The multilayer body 12 includes the first main surface-side outer layer portion 20a that is located on the first main surface 12a side and includes the plurality of ceramic layers 14 located between the first main surface 12a, and an outermost surface of the inner layer portion 18 on the first main surface 12a side and a straight line extending from the outermost surface. The first main surface-side outer layer portion 20a is an aggregate of the plurality of ceramic layers 14 located between the first main surface 12a and the inner electrode layer 16 closest to the first main surface 12a. The ceramic layer 14 used in the first main surface-side outer layer portion 20a may be the same as the ceramic layer 14 used in the inner layer portion 18.

Similarly, the multilayer body 12 includes the second main surface-side outer layer portion 20b that is located on the second main surface 12b side and includes the plurality of ceramic layers 14 located between the second main surface 12b, and an outermost surface of the inner layer portion 18 on the second main surface 12b side and a straight line extending from the outermost surface. The second main surface-side outer layer portion 20b is an aggregate of the plurality of ceramic layers 14 located between the second main surface 12b and the inner electrode layer 16 closest to the second main surface 12b. The ceramic layer 14 used in the second main surface-side outer layer portion 20b may be the same as the ceramic layer 14 used in the inner layer portion 18.

In addition, the multilayer body 12 includes a first side surface-side outer layer portion 22a that is located on the first side surface 12c side and includes the plurality of ceramic layers 14 located between the first side surface 12c and an outermost surface of the inner layer portion 18 on the first side surface 12c side.

Similarly, the multilayer body 12 includes a second side surface-side outer layer portion 22b that is located on the second side surface 12d side and includes the plurality of ceramic layers 14 located between the second side surface 12d and an outermost surface of the inner layer portion 18 on the second side surface 12d side.

The first side surface-side outer layer portion 22a and the second side surface-side outer layer portion 22b are also referred to as a W gap or a side gap.

Further, the multilayer body 12 includes a first end surface-side outer layer portion 24a that is located on the first end surface 12e side and includes the plurality of ceramic layers 14 located between the first end surface 12e and an outermost surface of the inner layer portion 18 on the first end surface 12e side.

Similarly, the multilayer body 12 includes a second end surface-side outer layer portion 24b that is located on the second end surface 12f side and includes the plurality of ceramic layers 14 located between the second end surface 12f and an outermost surface of the inner layer portion 18 on the second end surface 12f side.

In addition, the first end surface-side outer layer portion 24a and the second end surface-side outer layer portion 24b are also referred to as an L gap or an end gap.

The dimensions of the multilayer body 12 are not particularly limited.

The ceramic layer 14 can be made of, for example, a dielectric material as a ceramic material. As such a dielectric material, for example, a dielectric ceramic including a component such as BaTiO₃, CaTiO₃, SrTiO₃, or CaZrO₃ can be used. When the dielectric material is included as a main component, a secondary component having a lower content than a main component such as, for example, a Mn compound, an Fe compound, a Cr compound, a Co compound or a Ni compound may be added according to the desired characteristics of the multilayer body 12.

A thickness of the ceramic layer 14 after firing is, for example, preferably about 0.35 μm or more and about 0.60 μm or less. The number of the ceramic layers 14 to be stacked is, for example, preferably 10 or more and 2000 or less. The number of the ceramic layers 14 is the total number of the ceramic layers 14 of the inner layer portion 18 and the ceramic layers 14 of the first main surface-side outer layer portion 20a and the second main surface-side outer layer portion 20b.

The multilayer body 12 includes a plurality of first inner electrode layers 16a and a plurality of second inner electrode layers 16b as the plurality of inner electrode layers 16.

The plurality of first inner electrode layers 16a and the plurality of second inner electrode layers 16b may be alternately stacked with the ceramic layer 14 interposed therebetween, or the plurality of ceramic layers 14 in which the first inner electrode layers 16a are disposed may be stacked, and then the ceramic layers 14 in which the second inner electrode layers 16b are disposed may be stacked. In this way, the stacking pattern can be changed according to a desired capacitance value.

As shown in FIG. 16, the first inner electrode layer 16a includes a first counter electrode portion 26a facing the second inner electrode layer 16b, a first extended electrode portion 28a₁ extending from the first counter electrode portion 26a to the surface of the first end surface 12e of the multilayer body 12, and a second extended electrode portion 28a₂ extending from the first counter electrode portion 26a to the surface of the second end surface 12f of the multilayer body 12. Specifically, the first extended electrode portion 28a₁ is exposed on the surface of the first end surface 12e of the multilayer body 12, and the second extended electrode portion 28a₂ is exposed on the surface of the second end surface 12f of the multilayer body 12. Therefore, the first inner electrode layer 16a is not exposed on the surfaces of the first side surface 12c and the second side surface 12d of the multilayer body 12.

A shape of the first counter electrode portion 26a and shapes of the first extended electrode portion 28a₁ and the second extended electrode portion 28a₂ are not particularly limited, and are preferably or rectangular substantially rectangular. Meanwhile, the corner portion may be rounded.

In addition, lengths of the first extended electrode portion 28a₁ and the second extended electrode portion 28a₂ in the width direction y may be the same or substantially the same as a length of the first counter electrode portion 26a in the width direction y, or may be shorter than the length of the first counter electrode portion 26a in the width direction y.

In addition, the shapes of the first extended electrode portion 28a₁ and the second extended electrode portion 28a₂ may be tapered shapes.

As shown in FIG. 17, the second inner electrode layer 16b has a cross shape or substantially cross shape, and includes a second counter electrode portion 26b facing the first inner electrode layer 16a, a third extended electrode portion 28b₁ extended from the second counter electrode portion 26b to the surface of the first side surface 12c of the multilayer body 12, and a fourth extended electrode portion 28b₂ extended from the second counter electrode portion 26b to the surface of the second side surface 12d of the multilayer body 12. Specifically, the third extended electrode portion 28b₁ is exposed on the surface of the first side surface 12c of the multilayer body 12, and the fourth extended electrode portion 28b₂ is exposed on the surface of the second side surface 12d of the multilayer body 12. Therefore, the second inner electrode layer 16b is not exposed on the surface of the first end surface 12e and the surface of the second end surface 12f of the multilayer body 12.

A shape of the second counter electrode portion 26b and shapes of the third extended electrode portion 28b₁ and the fourth extended electrode portion 28b₂ are preferably rectangular or substantially rectangular. Meanwhile, the corner portion may be rounded.

A relationship between a dimension A in the length direction z connecting a side on the first end surface 12e side and a side on the second end surface 12f side of the second counter electrode portion 26b and a dimension B in the length direction z connecting a side on the first end surface 12e side and a side on the second end surface 12f side of the third extended electrode portion 28b₁ and the fourth extended electrode portion 28b₂ is preferably A≥B.

The shape of the third extended electrode portion 28b₁ may be a tapered shape whose width decreases toward the first side surface 12c, and the shape of the fourth extended electrode portion 28b₂ may be a tapered shape whose width decreases toward the second side surface 12d.

The multilayer body 12 includes a counter electrode portion 27. The counter electrode portion 27 is a portion where the first counter electrode portion 26a of the first inner electrode layer 16a and the second counter electrode portion 26b of the second inner electrode layer 16b face each other. The counter electrode portion 27 is configured as a portion of the inner layer portion 18. The counter electrode portion 27 is also referred to as a capacitor effective portion.

The first inner electrode layer 16a and the second inner electrode layer 16b can be made of an appropriate conductive material such as, for example, Ni, Cu, Ag, Pd, or Au, or an alloy including at least one of the metals such as an Ag—Pd alloy.

The number of the first inner electrode layers 16a and the second inner electrode layers 16b is not particularly limited, and is, for example, preferably about 10 or more and 2000 or less in total.

A thickness of the first inner electrode layer 16a is not particularly limited, and is, for example, preferably about 0.40 μm or more and about 0.50 μm or less.

A thickness of the second inner electrode layer 16b is not particularly limited, and is, for example, preferably about 0.40 μm or more and about 0.50 μm or less.

### (2) Outer Electrode

The outer electrode 30 is disposed on the first end surface 12e side and the second end surface 12f side, the first side surface 12c side and the second side surface 12d side, and the first main surface 12a and the second main surface 12b of the multilayer body 12.

The outer electrode 30 includes a first outer electrode 30a, a second outer electrode 30b, a third outer electrode 30c, and a fourth outer electrode 30d.

The first outer electrode 30a is connected to the first inner electrode layer 16a and is disposed on the surface of the first end surface 12e. In addition, the first outer electrode 30a extends from the first end surface 12e of the multilayer body 12 to be disposed on a portion of the first main surface 12a, a portion of the second main surface 12b, a portion of the first side surface 12c, and a portion of the second side surface 12d. In this case, the first outer electrode 30a is electrically connected to the first extended electrode portion 28a₁ of the first inner electrode layer 16a.

The second outer electrode 30b is connected to the first inner electrode layer 16a and is disposed on the surface of the second end surface 12f. In addition, the second outer electrode 30b extends from the second end surface 12f of the multilayer body 12 to be disposed on a portion of the first main surface 12a, a portion of the second main surface 12b, a portion of the first side surface 12c, and a portion of the second side surface 12d. In this case, the second outer electrode 30b is electrically connected to the second extended electrode portion 28a₂ of the first inner electrode layer 16a.

The third outer electrode 30c is connected to the second inner electrode layer 16b and is disposed on the surface of the first side surface 12c. In addition, the third outer electrode 30c extends from the first side surface 12c of the multilayer body 12 to be disposed on a portion of the first main surface 12a and a portion of the second main surface 12b. In this case, the third outer electrode 30c is electrically connected to the third extended electrode portion 28b₁ of the second inner electrode layer 16b. The third outer electrode 30c may be disposed only on the surface of the first side surface 12c.

The fourth outer electrode 30d is connected to the second inner electrode layer 16b and is disposed on the surface of the second side surface 12d. In addition, the fourth outer electrode 30d extends from the second side surface 12d of the multilayer body 12 to be disposed on a portion of the first main surface 12a and a portion of the second main surface 12b. In this case, the fourth outer electrode 30d is electrically connected to the fourth extended electrode portion 28b₂ of the second inner electrode layer 16b. The fourth outer electrode 30d may be disposed only on the surface of the second side surface 12d.

In the multilayer body 12, the first counter electrode portion 26a of the first inner electrode layer 16a and the second counter electrode portion 26b of the second inner electrode layer 16b face each other with the ceramic layer 14 interposed therebetween, thus generating an electrostatic capacitance. Therefore, the electrostatic capacitance can be obtained between the first outer electrode 30a and the second outer electrode 30b to which the first inner electrode layer 16a is connected and the third outer electrode 30c and the fourth outer electrode 30d to which the second inner electrode layer 16b is connected, and the characteristics of the capacitor are provided.

The outer electrode 30 includes a base electrode layer 32 including a metal component and a glass component and a plating layer 34 disposed on the surface of the base electrode layer 32. The plating layer 34 includes a lower plating layer and an upper plating layer.

The first outer electrode 30a includes a first base electrode layer 32a including a metal component, a first lower plating layer 34a₁ disposed on the first base electrode layer 32a, and a first upper plating layer 34a₂ disposed on the first lower plating layer 34a₁. In addition, the first outer electrode 30a has a first plating exposed region 35a exposed on a surface of the first outer electrode 30a.

The second outer electrode 30b includes a second base electrode layer 32b including a metal component, a second lower plating layer 34b₁ disposed on the second base electrode layer 32b, and a second upper plating layer 34b₂ disposed on the second lower plating layer 34b₁. In addition, the second outer electrode 30b includes a second plating exposed region 35b exposed on a surface of the second outer electrode 30b.

The third outer electrode 30c includes a third base electrode layer 32c including a metal component, a third lower plating layer 34c₁ disposed on the third base electrode layer 32c, and a third upper plating layer 34c₂ disposed on the third lower plating layer 34c₁.

The fourth outer electrode 30d includes a fourth base electrode layer 32d including a metal component, a fourth lower plating layer 34d₁ disposed on the fourth base electrode layer 32d, and a fourth upper plating layer 34d₂ disposed on the fourth lower plating layer 34d₁.

### (2-1) Base Electrode Layer

The base electrode layer 32 includes a first base electrode layer 32a, a second base electrode layer 32b, a third base electrode layer 32c, and a fourth base electrode layer 32d.

The first base electrode layer 32a is connected to the first inner electrode layer 16a and is disposed on the surface of the first end surface 12e. In addition, the first base electrode layer 32a extends from the first end surface 12e to a portion of the first main surface 12a, a portion of the second main surface 12b, a portion of the first side surface 12c, and a portion of the second side surface 12d. In this case, the first base electrode layer 32a is electrically connected to the first extended electrode portion 28a₁ of the first inner electrode layer 16a.

The second base electrode layer 32b is connected to the first inner electrode layer 16a and is disposed on the surface of the second end surface 12f. In addition, the second base electrode layer 32b extends from the second end surface 12f to a portion of the first main surface 12a, a portion of the second main surface 12b, a portion of the first side surface 12c, and a portion of the second side surface 12d. In this case, the second base electrode layer 32b is electrically connected to the second extended electrode portion 28a₂ of the first inner electrode layer 16a.

The third base electrode layer 32c is connected to the second inner electrode layer 16b and is disposed on the surface of the first side surface 12c. In addition, the third base electrode layer 32c extends from the first side surface 12c to a portion of the first main surface 12a and a portion of the second main surface 12b. In this s case, the third base electrode layer 32c is electrically connected to the third extended electrode portion 28b₁ of the second inner electrode layer 16b.

The fourth base electrode layer 32d is connected to the second inner electrode layer 16b and is disposed on the surface of the second side surface 12d. In addition, the fourth base electrode layer 32d extends from the second side surface 12d to a portion of the first main surface 12a and a portion of the second main surface 12b. In this case, the fourth base electrode layer 32d is electrically connected to the fourth extended electrode portion 28b₂ of the second inner electrode layer 16b.

The base electrode layer 32 includes at least one of a baked layer, a conductive resin layer, a thin film layer, and the like.

Hereinafter, a configuration of each of cases where the base electrode layer 32 is formed of the above-mentioned baked layer, conductive resin layer, and thin film layer will be described.

Case where Base Electrode Layer is Baked Layer

The baked layer includes a glass component and a metal component. The glass component of the baked layer includes, for example, at least one of B, Si, Ba, Mg, Al, Li, or the like. The metal component of the baked layer includes, for example, at least one of Cu, Ni, Ag, Pd, an Ag—Pd alloy, Au, or the like. The baked layer is obtained by applying a conductive paste including a glass component and a metal component to the multilayer body 12 and performing a baking treatment. The baked layer may be obtained by simultaneously firing a stacked chip having the inner electrode layer 16 and the ceramic layer 14 and a conductive paste applied to the stacked chip, or may be obtained by firing the stacked chip having the inner electrode layer 16 and the ceramic layer 14 to obtain the multilayer body 12 and then applying the conductive paste to the multilayer body 12 and performing a baking treatment. When the baked layer is obtained by simultaneously firing the stacked chip including the inner electrode layer 16 and the ceramic layer 14 and the conductive paste applied to the stacked chip, the baked layer is preferably formed by baking a material to which a dielectric material is added instead of the glass component. The baked layer may include a plurality of layers.

When the dielectric material is included in the base electrode layer 32 instead of the glass component, the close-contact property between the multilayer body 12 and the base electrode layer 32 can be improved. The base electrode layer 32 may include both the glass component and the dielectric component.

As the dielectric material included in the base electrode layer 32, the same kind of dielectric material as the ceramic layer 14 may be used, or a different kind of dielectric material may be used. The dielectric component includes, for example, at least one of BaTiO₃, CaTiO₃, (Ba,Ca)TiO₃, SrTiO₃, CaZro₃, or the like.

When the first base electrode layer 32a is the baked layer, a thickness in the length direction z of the central portion in the height direction x of the first base electrode layer 32a located on the first end surface 12e is, for example, preferably about 3 μm or more and about 20 μm or less.

In addition, when the second base electrode layer 32b is the baked layer, a thickness in the length direction z of the central portion in the height direction x of the second base electrode layer 32b located on the second end surface 12f is, for example, preferably about 3 μm or more and about 20 μm or less.

In addition, when the base electrode layer 32 is provided on the first main surface 12a and the second main surface 12b by the baked layer, a thickness in the height direction x, which connects the first main surface 12a and the second main surface 12b, of the central portion in the length direction z of the first base electrode layer 32a located on the first main surface 12a and the second main surface 12b is preferably, for example, about 3 μm or more and about 20 μm or less (a thickness of the base electrode layer in the central portion of an e dimension), and a thickness in the height direction x, which connects the first main surface 12a and the second main surface 12b, of the central portion in the length direction z of the second base electrode layer 32b located on the first main surface 12a and the second main surface 12b is preferably, for example, about 3 μm or more and about 20 μm or less (a thickness of the base electrode layer in the central portion of an e dimension).

Further, when the base electrode layer 32 is provided on the first side surface 12c and the second side surface 12d by the baked layer, a thickness in the width direction y, which connects the first side surface 12c and the second side surface 12d, of the central portion in the length direction z of the first base electrode layer 32a located on the first side surface 12c and the second side surface 12d is preferably, for example, about 3 μm or more and about 20 μm or less (a thickness of the base electrode layer in the central portion of the end surface), and a thickness in the width direction y, which connects the first side surface 12c and the second side surface 12d, of the central portion in the length direction z of the second base electrode layer 32b located on the first side surface 12c and the second side surface 12d is preferably, for example, about 3 μm or more and about 20 μm or less (a thickness of the base electrode layer in the central portion of the side surface).

Case where Base Electrode Layer is Conductive Resin Layer

When the conductive resin layer is provided as the base electrode layer 32, the conductive resin layer may be disposed on the baked layer to cover the baked layer, or may be directly disposed on the multilayer body 12.

The conductive resin layer includes a metal and a thermosetting resin.

The conductive resin layer may completely cover the base electrode layer or may cover a portion of the base electrode layer.

Since the conductive resin layer includes a thermosetting resin, the conductive resin layer is more flexible than, for example, a conductive layer formed of a plating film or a fired product of a conductive paste. Therefore, even when a physical impact or an impact caused by a thermal cycle is applied to the three-terminal multilayer ceramic capacitor 100, the conductive resin layer functions as a buffer layer, and it is possible to prevent cracks from occurring in the three-terminal multilayer ceramic capacitor 100.

As the metal included in the conductive resin layer, for example, Ag, Cu, Ni, Sn, Bi, or an alloy including these metals can be used.

In addition, a metal powder whose surface is coated with, for example, Ag can also be used. In a case of using a metal powder whose surface is coated with Ag, for example, it is preferable to use Cu, Ni, Sn, Bi, or an alloy powder thereof as the metal powder. The reason for using the conductive metal powder of Ag for the conductive metal is that Ag is suitable for an electrode material because Ag has the lowest specific resistance among metals, and Ag does not oxidize and has high weather resistance because Ag is a noble metal. In addition, the reason for using the Ag-coated metal powder is that it is possible to make the metal of the base material inexpensive while maintaining the characteristics of Ag.

Further, as the metal included in the conductive resin layer, for example, Cu and Ni which have been subjected to an oxidation prevention treatment can also be used.

As the metal included in the conductive resin layer, for example, a metal powder whose surface is coated with Sn, Ni, and Cu can also be used. In a case of using a metal powder whose surface is coated with Sn, Ni, and Cu, for example, it is preferable to use Ag, Cu, Ni, Sn, Bi, or an alloy powder thereof as the metal powder.

The metal included in the conductive resin layer is preferably included in an amount of, for example, about 35 vol % or more and about 75 vol % or less with respect to the volume of the entire conductive resin.

An average particle diameter of the metal included in the conductive resin layer is not particularly limited. An average particle diameter of a conductive filler may be, for example, about 0.3 μm or more and about 10 μm or less.

The metal included in the conductive resin layer is mainly responsible for the conductivity of the conductive resin layer. Specifically, the conductive fillers come into contact with each other to provide a current path inside the conductive resin layer.

As the metal included in the conductive resin layer, a metal having a spherical shape or a flat shape can be used, and it is preferable to use a mixture of a spherical metal powder and a flat metal powder.

As the resin of the conductive resin layer, for example, various known thermosetting resins such as an epoxy resin, a phenoxy resin, a phenol resin, a urethane resin, a silicone resin, or a polyimide resin can be used. Among these, an epoxy resin having excellent heat resistance, moisture resistance, close-contact property, and the like is one of the more suitable resins.

The resin included in the conductive resin layer is, for example, preferably included in an amount of about 25 vol % or more and about 65 vol % or less with respect to the volume of the entire conductive resin.

In addition, the conductive resin layer preferably includes a curing agent together with the thermosetting resin. When an epoxy resin is used as a base resin, various known compounds such as, for example, a phenol-based compound, an amine-based compound, an acid anhydride-based compound, an imidazole-based compound, an active ester-based compound, or an amide-imide-based compound can be used as the curing agent of the epoxy resin.

The conductive resin layer may include a plurality of layers.

A thickness of the conductive resin layer located in a central portion in the height direction x of the multilayer body 12 located on the first end surface 12e and the second end surface 12f is, for example, preferably about 3 μm or more and about 30 μm or less.

In addition, when the conductive resin layer is also provided on the first main surface 12a and the second main surface 12b and on the first side surface 12c and the second side surface 12d, a thickness of a conductive resin layer in central portion in the length direction z of the conductive resin layer located on the first main surface 12a and the second main surface 12b and on the first side surface 12c and the second side surface 12d is, for example, preferably about 3 μm or more and about 30 μm or less.

Case where Base Electrode Layer is Thin Film Layer

When the thin film layer is provided as the base electrode layer 32, the thin film layer is formed using a thin film forming method such as, for example, a sputtering method or a vapor deposition method, and is a layer of about 1 μm or less in which metal particles are deposited.

### (2-2) Plating Layer

A first plating layer 34a, a second plating layer 34b, a third plating layer 34c, and a fourth plating layer 34d, which are plating layers 34 that can be disposed on the base electrode layer 32, will be described with reference to FIGS. 14 to 17. The plating layer 34 includes a plating exposed region 35.

The first plating layer 34a is disposed to cover the first base electrode layer 32a on the first end surface 12e side. Further, the first plating layer 34a may be disposed to cover the first base electrode layer 32a on the first main surface 12a side, the second main surface 12b side, the first side surface 12c side, and the second side surface 12d side. Meanwhile, the first plating layer 34a may be disposed only on the first base electrode layer 32a on the first end surface 12e side. The first plating layer 34a includes a first lower plating layer 34a₁ disposed on the first base electrode layer 32a, and a first upper plating layer 34a₂ disposed on the first lower plating layer 34a₁. The first upper plating layer 34a₂ is disposed on the first lower plating layer 34a₁ to expose a portion of the first lower plating layer 34a₁. That is, the first upper plating layer 34a₂ is disposed on the first lower plating layer 34a₁ except for the first plating exposed region 35a exposed on the surface of the first outer electrode 30a so that the first lower plating layer 34a₁ includes the first plating exposed region 35a. In the present example embodiment, the first plating exposed region 35a is disposed on the first main surface 12a. In this case, the second main surface 12b of the three-terminal multilayer ceramic capacitor 100 becomes the mounting surface on the mounting substrate.

It is preferable that the first upper plating layer 34a₂ covers an end portion of the first lower plating layer 34a₁. As a result, peeling of the first lower plating layer 34a₁ can be reduced or prevented.

A first ratio of an area of the first plating exposed region 35a to an area of an exposed region of the first outer electrode 30a on the first main surface 12a of the multilayer body 12 when viewed in the height direction x is, for example, preferably about 0.4% or more and about 83.4% or less. Since the first ratio is about 0.4% or more, for example, hydrogen released from the first and second inner electrode layers 16a and 16b, the first and second base electrode layers 32a and 32b, and the first and second lower plating layers 34a₁ and 34b₁ can be sufficiently emitted from the first plating exposed region 35a to the outside of the three-terminal multilayer ceramic capacitor 100, and the deterioration of the insulation resistance due to hydrogen can be reduced or prevented. In addition, since the first ratio is about 83.4% or less, a ratio of the first lower plating layer 34a₁ that is not covered with the first upper plating layer 34a₂ can be reduced or prevented. As a result, it is possible to reduce or prevent a decrease in the moisture resistance due to water vapor intrusion into the three-terminal multilayer ceramic capacitor 100 from the first plating exposed region 35a.

The first ratio is, for example, more preferably about 1.17% or more and about 83.4% or less. The first ratio is, for example, even more preferably about 1.40% or more and about 83.4% or less. The first ratio is, for example, even more preferably about 1.40% or more and about 25.0% or less. The calculation method of the first ratio is the same as that in the first example embodiment.

The second plating layer 34b is disposed to cover the second base electrode layer 32b on the second end surface 12f side. Further, the second plating layer 34b may be disposed to cover the second base electrode layer 32b on the first main surface 12a side, the second main surface 12b side, the first side surface 12c side, and the second side surface 12d side. Meanwhile, the second plating layer 34b may be disposed only on the second base electrode layer 32b on the second end surface 12f side. The second plating layer 34b includes a second lower plating layer 34b₁ disposed on the second base electrode layer 32b, and a second upper plating layer 34b₂ disposed on the second lower plating layer 34b₁. The second upper plating layer 34b₂ is disposed on the second lower plating layer 34b₁ to expose a portion of the second lower plating layer 34b₁. That is, the second upper plating layer 34b₂ is disposed on the second lower plating layer 34b₁ except for the second plating exposed region 35b exposed on the surface of the second outer electrode 30b so that the second lower plating layer 34b₁ includes the second plating exposed region 35b. In the present example embodiment, the second plating exposed region 35b is disposed on the first main surface 12a. In this case, the second main surface 12b of the three-terminal multilayer ceramic capacitor 100 becomes the mounting surface on the mounting substrate.

It is preferable that the second upper plating layer 34b₂ covers the end portion of the second lower plating layer 34b₁. As a result, peeling of the second lower plating layer 34b₁ can be reduced or prevented.

For the same reason as the first ratio, a second ratio of the second plating exposed region 35b to an exposed region of the second outer electrode 30b on the first main surface 12a of the multilayer body 12 when viewed in the height direction x is, for example, preferably about 0.4% or more and about 83.4% or less. The second ratio is, for example, more preferably about 1.17% or more and about 83.4% or less. The second ratio is, for example, even more preferably about 1.40% or more and about 83.4% or less. The second ratio is, for example, even more preferably about 1.40% or more and about 25.0% or less. The calculation method of the second ratio is the same as that in the first example embodiment.

In the above, the first ratio and the second ratio are obtained as the exposure ratio, but the exposure ratio may be a ratio of the total area of the first plating exposed region 35a and the second plating exposed region 35b to the total area of the exposed regions of the first outer electrode 30a and the second outer electrode 30b. Then, the total exposure ratio is, for example, preferably about 0.4% or more and about 83.4% or less.

The third plating layer 34c is disposed to cover the third base electrode layer 32c on the first side surface 12c side. Further, the third plating layer 34c may be disposed to cover the third base electrode layer 32c on the first main surface 12a side and the second main surface 12b side. Meanwhile, the third plating layer 34c may be disposed only on the third base electrode layer 32c on the first side surface 12c side. The third plating layer 34c has a third lower plating layer 34c₁ disposed on the third base electrode layer 32c, and a third upper plating layer 34c₂ disposed on the third lower plating layer 34c₁. The third upper plating layer 34c₂ covers the third lower plating layer 34c₁, and the third lower plating layer 34c₁ does not have an exposed region.

The fourth plating layer 34d is disposed to cover the fourth base electrode layer 32d on the second side surface 12d side. Further, the fourth plating layer 34d may be disposed to cover the fourth base electrode layer 32d on the first main surface 12a side and the second main surface 12b side. Meanwhile, the fourth plating layer 34d may be disposed only on the fourth base electrode layer 32d on the second side surface 12d side. The fourth plating layer 34d has a fourth lower plating layer 34d₁ disposed on the fourth base electrode layer 32d, and a fourth upper plating layer 34d₂ disposed on the fourth lower plating layer 34d₁. The fourth upper plating layer 34d₂ covers the fourth lower plating layer 34d₁, and the fourth lower plating layer 34d₁ does not have an exposed region.

In the three-terminal multilayer ceramic capacitor 100 of the present example embodiment, a positive potential is applied to the first outer electrode 30a including the first plating exposed region 35a and the second outer electrode 30b including the second plating exposed region 35b, and a negative potential is applied to the third outer electrode 30c and the fourth outer electrode 30d.

The first to fourth plating layers 34a to 34d include, for example, at least one of Cu, Ni, Sn, Ag, Pd, an Ag—Pd alloy, Au, or the like.

For example, it is preferable that the first to fourth lower plating layers 34a₁ to 34d₁ are Ni plating layers and the first to fourth upper plating layers 34a₂ to 34d₂ are Sn plating layers.

The first to fourth lower plating layers 34a₁ to 34d₁ including the Ni plating layer are used to prevent the base electrode layer 32 from being corroded by solder when the three-terminal multilayer ceramic capacitor 100 is mounted. In addition, the first to fourth upper plating layers 34a₂ to 34d₂ including the Sn plating layer are used to improve the wettability of solder when the three-terminal multilayer ceramic capacitor 100 is mounted, and to facilitate mounting.

Thicknesses of the first lower plating layer 34a₁ and the first upper plating layer 34a₂ on the first main surface 12a, the second main surface 12b, the first end surface 12e, the first side surface 12c, and the second side surface 12d are, for example, preferably about 2 μm or more and about 7 μm or less. Thicknesses of the second lower plating layer 34b₁ and the second upper plating layer 34b₂ on the first main surface 12a, the second main surface 12b, the second end surface 12f, the first side surface 12c, and the second side surface 12d are, for example, preferably about 2 μm or more and about 7 μm or less. In addition, thicknesses of the third lower plating layer 34c₁ and the third upper plating layer 34c₂ on the first main surface 12a, the second main surface 12b, and the first side surface 12c are, for example, preferably about 2 μm or more and about 7 μm or less. Thicknesses of the fourth lower plating layer 34d₁ and the fourth upper plating layer 34d₂ on the first main surface 12a, the second main surface 12b, and the second side surface 12d are, for example, preferably about 2 μm or more and about 7 μm or less.

When the conductive resin layer is provided on the base electrode layer 32, the plating layer 34 is disposed to cover the conductive resin layer. Even in this case, the Ni plating layer, which is the lower plating layer, of the plating layer 34 prevents the conductive resin layer from being eroded by the solder, and the Sn plating layer, which is the upper plating layer, improves the wettability of the solder.

### (3) Dimensions of Three-Terminal Multilayer Ceramic Capacitor

A dimension in the length direction z of the three-terminal multilayer ceramic capacitor 100 including the multilayer body 12 and the first outer electrode 30a to the fourth outer electrode 30d is defined as an L dimension, a dimension in the height direction x of the three-terminal multilayer ceramic capacitor 100 including the multilayer body 12 and the first outer electrode 30a to the fourth outer electrode 30d is defined as a T dimension, and a dimension in the width direction y of the three-terminal multilayer ceramic capacitor 100 including the multilayer body 12 and the first outer electrode 30a to the fourth outer electrode 30d is defined as a W dimension.

The dimensions of the three-terminal multilayer ceramic capacitor 100 are not particularly limited, and are, for example, as follows: the L dimension in the length direction z is about 0.2 mm or more and about 6.5 mm or less, the W dimension in the width direction y is about 0.1 mm or more and about 5.5 mm or less, and the T dimension in the height direction x is about 0.1 mm or more and about 6.5 mm or less. The dimensions of the three-terminal multilayer ceramic capacitor 100 can be measured with a microscope.

### 2. Method of Manufacturing Three-Terminal Multilayer Ceramic Capacitor

Next, an example of a method of manufacturing the three-terminal multilayer ceramic capacitor will be described.

(Step 1) First, a dielectric sheet for the ceramic layer and a conductive paste for the inner electrode layer are prepared. The dielectric sheet and the conductive paste for the inner electrode layer include a binder and a solvent. The binder and the solvent may be known ones.

(Step 2) Then, the conductive paste for the inner electrode layer is applied on the dielectric sheet in a predetermined pattern through, for example, screen printing or gravure printing. As a result, a dielectric sheet on which a pattern of the first inner electrode layer is formed and a dielectric sheet on which a pattern of the second inner electrode layer is formed are prepared. More specifically, it is possible to print the pattern of each inner electrode layer by separately preparing a screen plate for printing the first inner electrode layer and a screen plate for printing the second inner electrode layer, and using a printing machine capable of separately printing the two types of screen plates.

(Step 3) Subsequently, a predetermined number of the dielectric sheets for the outer layer on which the pattern of the inner electrode layer is not printed are stacked, thus forming a portion that becomes the second main surface-side outer layer portion on the second main surface side. Then, the dielectric sheet on which the pattern of the first inner electrode layer is printed on the portion that becomes the second main surface-side outer layer portion and the dielectric sheet on which the pattern of the second inner electrode layer is printed are sequentially stacked to have the structure of the present invention, thereby forming a portion that becomes the inner layer portion. A predetermined number of the dielectric sheets for the outer layer on which the pattern of the inner electrode layer is not printed are stacked on the portion that becomes the inner layer portion, thereby forming a portion that becomes the first main surface-side outer layer portion on the first main surface side. As a result, the stacked sheet is produced.

(Step 4) Next, the stacked sheet is pressed in the stacking direction by, for example, an isostatic press, thus producing a stacked block.

(Step 5) Then, the stacked block is cut to have a predetermined size, and thus a stacked chip is cut out. In this case, a corner portion and a ridge portion of the stacked chip may be rounded through barrel polishing or the like.

(Step 6) Subsequently, the multilayer body is produced by firing the cut-out stacked chip. A firing temperature is determined depending on the material of the ceramic layer or the inner electrode layer, and is, for example, preferably about 900° C. or higher and about 1400° C. or lower.

(Step 7) Next, the third base electrode layer 32c of the third outer electrode 30c is formed on the first side surface 12c of the multilayer body 12 obtained by firing, and the fourth base electrode layer 32d of the fourth outer electrode 30d is formed on the second side surface 12d of the multilayer body 12.

Case where Base Electrode Layer is Baked Layer

When the baked layer is formed as the third base electrode layer 32c and the fourth base electrode layer 32d, a conductive paste including a glass component and a metal component is applied, and then a baking treatment is performed to form the base electrode layer. A temperature of the baking treatment at this time is, for example, preferably about 700° C. or higher and about 900° C. or lower.

Here, as a method of forming the baked layer, various methods can be used. For example, a method of extruding a conductive paste through a slit and applying the conductive paste can be used. In the case of this method, by increasing the extrusion amount of the conductive paste, the base electrode layer 32 can be formed not only on the first side surface 12c and the second side surface 12d but also on a portion of the first main surface 12a and a portion of the second main surface 12b.

In addition, the baked layer can also be formed using a roller transfer method, for example. In the case of the roller transfer method, when the base electrode layer 32 is formed not only on the first side surface 12c and the second side surface 12d but also on a portion of the first main surface 12a and a portion of the second main surface 12b, a pressing pressure during the roller transfer is increased, so that the base electrode layer 32 can be formed on a portion of the first main surface 12a and a portion of the second main surface 12b.

Next, the first base electrode layer 32a of the first outer electrode 30a is formed on the first end surface 12e of the multilayer body obtained by firing, and the second base electrode layer 32b of the second outer electrode 30b is formed on the second end surface 12f.

When the baked layer is formed as the first base electrode layer 32a and the second base electrode layer 32b as with the third base electrode layer 32c and the fourth base electrode layer 32d, a conductive paste including a glass component and a metal component is applied, and then a baking treatment is performed to form the base electrode layer. A temperature of the baking treatment at this time is, for example, preferably about 700° C. or higher and about 900° C. or lower.

As a method of applying the conductive paste to both end surfaces of the multilayer body, for example, a dip method or a screen printing method is used.

In the baking treatment, the third base electrode layer 32c and the fourth base electrode layer 32d, and the first base electrode layer 32a and the second base electrode layer 32b may be simultaneously baked, or may be baked on the both side surfaces 12c and 12d side and on the both end surfaces 12e and 12f side, respectively.

In addition, when the base electrode layer is formed of a baked layer, the baked layer may include a dielectric component. In this case, the baked layer may include a dielectric component instead of the glass component, or may include both.

The dielectric component is preferably, for example, a dielectric material of the same kind as the multilayer body. When the baked layer includes the dielectric component, it is preferable to form a multilayer body in which the baked layer is formed by applying a conductive paste to the stacked chip before firing and simultaneously baking (firing) the stacked chip before firing and the conductive paste applied to the stacked chip before firing. A temperature (firing temperature) of the baking treatment at this time is, for example, preferably about 900° C. or higher and about 1400° C. or lower.

Case where Base Electrode Layer is Conductive Resin Layer

When the base electrode layer 32 is formed of a conductive resin layer, the conductive resin layer can be formed by the following method. The conductive resin layer may be formed on a surface of the baked layer, or the conductive resin layer may be directly formed on the multilayer body 12 alone without forming the baked layer.

As a method of forming the conductive resin layer, for example, a conductive resin paste including a thermosetting resin and a metal component is applied onto the baked layer or the multilayer body 12, and a heat treatment is performed at a temperature of about 250° C. or higher and about 550° C. or lower to thermally cure the resin and form the conductive resin layer. The atmosphere during the heat treatment at this time is, for example, preferably N2 atmosphere. In addition, in order to prevent scattering of the resin and to prevent oxidation of various metal components, an oxygen concentration is, for example, preferably reduced or prevented to about 100 ppm or less.

As a method of applying the conductive resin paste, for example, a method of extruding the conductive resin paste through a slit and applying the conductive resin paste or a roller transfer method can be used, as with the method of forming the base electrode layer 32 with the baked layer.

Case where Base Electrode Layer is Thin Film Layer

In addition, when the base electrode layer 32 is formed of a thin film layer, the base electrode layer can be formed using a thin film forming method such as, for example, a sputtering method or a vapor deposition method at a desired position for forming the outer electrode 30 by performing masking or the like. The base electrode layer formed of the thin film layer is a layer of, for example, about 1 μm or less in which metal particles are deposited.

(Step 8) Next, the plating layer 34 is formed. The plating layer 34 is formed on the surface of the base electrode layer 32. More specifically, for example, on the base electrode layer 32, a Ni plating layer is formed as the lower plating layer and a Sn plating layer is formed as the upper plating layer. In the present example embodiment, as the plating layer 34, the first lower plating layer 34a₁, the second lower plating layer 34b₁, the third lower plating layer 34c₁, and the fourth lower plating layer 34d₁, which are Ni plating layers, and the first upper plating layer 34a₂, the second upper plating layer 34b₂, the third upper plating layer 34c₂, and the fourth upper plating layer 34d₂, which are Sn plating layers, are sequentially formed on the base electrode layer 32. The Ni plating layer and the Sn plating layer are sequentially formed using, for example, a barrel plating method. In performing the plating treatment, either electrolytic plating or electroless plating may be used. The electroless plating requires a pretreatment with a catalyst or the like in order to improve a plating deposition rate, which is a disadvantage in that the process becomes complicated. Accordingly, it is preferable to use the electrolytic plating in general.

(Step 9) Next, the first and second upper plating layers 34a₂ and 34b₂ (Sn plating layers) are treated such that the first and second lower plating layers 34a₁ and 34b₁ (Ni plating layers) have a predetermined exposure ratio. As the treatment method, for example, a scraping method, a melting method, a method of laser processing, or a method of using a resist can be adopted.

In the scraping method, a soft Sn plating layer is scraped by bringing a metal terminal having a size of, for example, about φ30 to about 100 μm into contact with the first and second upper plating layers 34a₂ and 34b₂ so that the first and second lower plating layers 34a₁ and 34b₁ (Ni plating layers) have a predetermined exposure ratio.

In the melting method, a formed body after the plating layer 34 is formed is immersed in an ENSTRIP agent (release agent). For example, heights of a plurality of the formed bodies after the plating layer 34 is formed are aligned with an alignment jig, and one surface of the formed bodies is immersed in the ENSTRIP agent to dissolve the Sn plating layers so that the first and second lower plating layers 34a₁ and 34b₁ (Ni plating layers) have a predetermined exposure ratio. At this time, it is preferable to immerse the first main surface 12a (and/or the second main surface 12b) side. As a result, it is possible to prevent the first end surface 12e side, the second end surface 12f side, the first side surface 12c side, and the second side surface 12d side from being immersed in the inner electrode layer 16.

In the method of laser processing, a plurality of the formed bodies after the plating layer 34 is formed are aligned, and predetermined areas of the Sn plating layers of each formed body are scraped by a laser so that the first and second lower plating layers 34a₁ and 34b₁ (Ni plating layers) have a predetermined exposure ratio.

In addition, even when a resist is used, the first and second lower plating layers 34a₁ and 34b₁ (Ni plating layers) having a predetermined exposure ratio can be formed.

As described above, the three-terminal multilayer ceramic capacitor 100 according to the present example embodiment is manufactured.

The three-terminal multilayer ceramic capacitor 100 according to the present example embodiment has the same or substantially the same advantageous effects as the two-terminal multilayer ceramic capacitor 10 of the first example embodiment.

### 3. Modified Example of Three-Terminal Multilayer Ceramic Capacitor

Next, a modified example of the three-terminal multilayer ceramic capacitor 100 will be described.

The outer electrode 30 of the second example embodiment includes the base electrode layer 32 and the plating layer 34. Differently from this, the outer electrode 30 may include the plating layer 34 and does not include the base electrode layer 32 in some cases.

Hereinafter, although not shown, a structure in which the plating layer 34 is provided without providing the base electrode layer 32 for the first to fourth outer electrodes 30a to 30d will be described.

Each of the first to fourth outer electrodes 30a to 30d is not provided with the base electrode layer 32 in some cases, and the plating layer 34 may be directly formed on the surface of the multilayer body 12. That is, the three-terminal multilayer ceramic capacitor 100 may have a structure in which the first end surface 12e, the second end surface 12f, the first side surface 12c, and the second side surface 12d are subjected to a plating treatment and the plating layer 34 electrically connected to the first inner electrode layer 16a or the second inner electrode layer 16b is formed. In such a case, the plating layer 34 may be formed by the plating treatment after a catalyst is disposed on the surface of the multilayer body 12 as a pretreatment. In performing the plating treatment, either electrolytic plating or electroless plating may be used. The electroless plating requires a pretreatment with a catalyst or the like in order to improve a plating deposition rate, which is a disadvantage in that the process becomes complicated. Therefore, it is preferable to use the electrolytic plating in general. As the plating method, for example, barrel plating is preferably used.

When the plating layer 34 is directly formed on the multilayer body 12 without providing the base electrode layer 32, a reduced thickness of the base electrode layer 32 can be converted into a reduced height, that is, a thinner decrease, or a thickness of the multilayer body, that is, a thickness of the effective layer portion, so that the design freedom of the thickness of the multilayer body 12 can be improved.

The plating layer 34 includes first to fourth lower plating layers 34a₁ to 34d₁ (lower plating layers) formed on the surface of the multilayer body 12 and first to fourth upper plating layers 34a₂ to 34d₂ (upper plating layers) formed on the surfaces of the first to fourth lower plating layers 34a₁ to 34d₁. The first and second lower plating layers 34a₁ and 34b₁ include a plating exposed region that is not covered with the upper plating layer, as in the above-described example embodiment. It is preferable that the lower plating layer and the upper plating layer each include, for example, at least one metal selected from Cu, Ni, Sn, Pb, Au, Ag, Pd, Bi, or Zn, or an alloy including the metal.

Further, for example, the lower plating layer is preferably made of Ni having solder barrier performance, and the upper plating layer is preferably formed of Sn or Au having good solder wettability.

In addition, for example, when the first inner electrode layer 16a and the second inner electrode layer 16b are made of Ni, the lower plating layer is preferably made of Cu having good bondability with Ni. For the plating layer, the upper plating layer may be used as the outermost layer, or another plating electrode may be further formed on the surface of the upper plating layer.

Here, when the outer electrode 30 includes only of the plating layer 34 without providing the base electrode layer 32, a thickness of the plating layer 34 disposed without providing the base electrode layer 32 is, for example, preferably about 1.0 μm or more and about 20.0 μm or less per layer.

Further, it is preferable that the plating layer 34 does not include glass. A metal ratio per unit volume of the plating layer 34 is, for example, preferably about 99% by volume or more.

In the second example embodiment described above, the first lower plating layer 34a₁ includes the first plating exposed region 35a that is not covered with the first upper plating layer 34a₂, and the second lower plating layer 34b₁ includes the second plating exposed region 35b that is not covered with the second upper plating layer 34b₂. However, the exposed region is not limited to this, and as described in the modified example of the first example embodiment (see FIGS. 9 and 10), the outer electrode 30 may include a base exposed region 36 in which the base electrode layer 32 is not covered with the plating layer 34. For example, the first base electrode layer 32a may include a first base exposed region that is not covered with the first plating layer 34a. In addition, the second base electrode layer 32b may include a second base exposed region that is not covered with the second plating layer 34b. In this case, the first outer electrode 30a includes the first base exposed region 36a together with the first plating exposed region 35a, the second outer electrode 30b has the second base exposed region together with the second plating exposed region 35b, and a positive potential is applied to the first outer electrode 30a and the second outer electrode 30b.

It is preferable that the base exposed region 36 is disposed on the first main surface 12a. It is preferable that the second main surface 12b is a mounting surface. As a result, when solder is mainly applied to the first and second end surfaces 12e and 12f as shown in FIG. 6, the hydrogen of the absorption layer can be efficiently released from the first main surface 12a that is not applied with the solder and does not face the mounting substrate 40 through the base exposed region 36.

The base exposed region 36 may be disposed on any of the second main surface 12b, the first end surface 12e, the second end surface 12f, the first side surface 12c, and the second side surface 12d other than the first main surface 12a, as long as the solder is not applied.

In addition, the first plating exposed region 35a and the first base exposed region 36a may be provided on different surfaces.

In addition, it is preferable that the first base exposed region 36a is provided on the first end surface 12e side with respect to a tip portion of the first lower plating layer 34a₁ on the second end surface 12f side.

The first base exposed region 36a can be formed using the same or substantially the same method as the first plating exposed region 35a.

Although not shown, the third base electrode layer 32c may include a third base exposed region that is not covered with the third plating layer 34c, and the fourth base electrode layer 32d may include a fourth base exposed region that is not covered with the fourth plating layer 34d.

In the second example embodiment described above, the first plating exposed region 35a in which the first lower plating layer 34a₁ is not covered with the first upper plating layer 34a₂ is provided on the first main surface 12a. Similarly, the second plating exposed region 35b in which the second lower plating layer 34b₁ is not covered with the second upper plating layer 34b₂ is provided on the first main surface 12a. The present invention is not limited thereto, and the plating exposed region 35 need only be provided on at least any of the first main surface 12a, the second main surface 12b, the first end surface 12e, the second end surface 12f, the first side surface 12c, and the second side surface 12d.

In the second example embodiment described above, the first plating exposed region 35a of the first outer electrode 30a and the second plating exposed region 35b of the second outer electrode 30b are provided. However, in addition to the first plating exposed region 35a of the first outer electrode 30a and the second plating exposed region 35b of the second outer electrode 30b, a third plating exposed region in which the third lower plating layer 34c₁ is not covered with the third upper plating layer 34c₂ may be provided in the third outer electrode 30c, and a fourth plating exposed region in which the fourth lower plating layer 34d₁ is not covered with the fourth upper plating layer 34d₂ may be provided in the fourth outer electrode 30d. In this case, a positive potential is applied to either of the first and second outer electrodes 30a and 30b or the third and fourth outer electrodes 30c and 30d, and a negative potential is applied to the other.

A third ratio of an area of the third plating exposed region to an area of an exposed region of the third outer electrode 30c on the first main surface 12a when viewed in the direction of the first main surface is, for example, preferably about 0.4% or more and about 83.4% or less. Similarly, a fourth ratio of an area of the fourth plating exposed region to an area of an exposed region of the fourth outer electrode 30d on the first main surface 12a when viewed in the direction of the first main surface is, for example, preferably about 0.4% or more and about 83.4% or less. In addition, a ratio of the total of the first to fourth plating exposed regions 35a to 35d to the total of the exposed regions of the first to fourth outer electrodes 30a to 30d is, for example, preferably about 0.4% or more and about 83.4% or less.

Further, the first plating exposed region 35a is not provided in the first outer electrode 30a and the second plating exposed region 35b is not provided in the second outer electrode 30b in some cases, the third plating exposed region in which the third lower plating layer 34c₁ is not covered with the third upper plating layer 34c₂ may be provided in the third outer electrode 30c, and the fourth plating exposed region in which the fourth lower plating layer 34d₁ is not covered with the fourth upper plating layer 34d₂ may be provided in the fourth outer electrode 30d. In this case, a positive potential is applied to the third and fourth outer electrodes 30c and 30d.

In the second example embodiment described above, the first to fourth lower plating layers 34a₁ to 34d₁ are disposed to cover all of the first to fourth base electrode layers 32a to 32d. However, the present invention is not limited thereto, and the first lower plating layer 34a₁ may be disposed to cover a portion of the first base electrode layer 32a, the second lower plating layer 34b₁ may be disposed to cover a portion of the second base electrode layer 32b, the third lower plating layer 34c₁ may be disposed to cover a portion of the third base electrode layer 32c, and the fourth lower plating layer 34d₁ may be disposed to cover a portion of the fourth base electrode layer 32d.

### C. Experimental Example

### (1) Sample of Experimental Example

First, a two-terminal multilayer ceramic capacitor according to an example having the following specifications was manufactured according to the above-described method of manufacturing the multilayer ceramic capacitor.
Structure of multilayer ceramic capacitor: two-terminal (see FIG. 1)
Dimensions L×W×T of multilayer ceramic capacitor (including design value): about 1.13 mm×about 0.63 mm×about 0.63 mm
Material of ceramic layer: BaTiO₃
Electrostatic capacitance: about 22 μF
Rated voltage: about 4 V
Structure of outer electrode
Base electrode layer: electrode including conductive metal (Cu) and glass component
Film thickness of base electrode layer of end surface: film thickness of base electrode layer of central portion in height direction of base electrode layer located on first end surface and second end surface=about 12 μm
Film thickness of base electrode layer of main surface and side surface: film thickness of base electrode layer of central portion in length direction of base electrode layer located on first main surface, second main surface, first side surface, and second side surface=about 12 μm
Plating layer: two-layer structure of Ni plating layer and Sn plating layer
Film thickness of Ni plating layer on end surface: film thickness of Ni plating layer of central portion in height direction of Ni plating layer located on first end surface and second end surface=about 2 μm
Film thickness of Ni plating layer on main surface and side surface: film thickness of Ni plating layer of central portion in length direction of Ni plating layer located on first main surface and second main surface, and first side surface and second side surface=about 2 μm
Film thickness of Sn plating layer on end surface: film thickness of Sn plating layer of central portion in height direction of Sn plating layer located on first end surface and second end surface=about 3 μm
Film thickness of Sn plating layer of main surface and side surface: film thickness of Sn plating layer of central portion in length direction of Sn plating layer located on first main surface and second main surface, and first side surface and second side surface=about 3 μm
Exposure ratio of first lower plating layer and second lower plating layer (Ni plating layers) on first main surface
Exposure ratio=(exposed area of first lower plating layer and second lower plating layer)/areas of first outer electrode and second outer electrode on first main surface×100.
The areas of the first outer electrode and the second outer electrode on the first main surface were set to L (about 200 μm)×W (about 600 μm).

The exposure ratios of Examples 1 to 8 and Comparative Example 1 are as follows.
(Example 1) about 0.2%
(Example 2) about 0.4%
(Example 3) about 1.17%
(Example 4) about 1.4%
(Example 5) about 1.67%
(Example 6) about 25%
(Example 7) about 83.4%
(Example 8) about 89.2%
(Comparative Example 1) 0%

### (2) Experimental Results

For 100 samples of each of Examples 1 to 8 and Comparative Example 1, the deterioration of the insulation resistance (IR) by a PCBT test (about 125° C., about 95% RH, about 2 V, about 72 hr) in solder mounting was confirmed, and the number of deteriorated samples was counted.

The experimental results are shown in Table 1.

TABLE 1

| | Exposure | Deterioration of insulation |
|---|---|---|
| | ratio (%) | resistance (IR) (pieces) |
| Comparative Example 1 | 0.00 | 11/100 |
| Example 1 | 0.20 | 5/100 |
| Example 2 | 0.40 | 2/100 |
| Example 3 | 1.17 | 1/100 |
| Example 4 | 1.40 | 0/100 |
| Example 5 | 1.67 | 0/100 |
| Example 6 | 25.00 | 0/100 |
| Example 7 | 83.40 | 4/100 |
| Example 8 | 89.20 | 8/100 |

From the results in Table 1, in Comparative Example 1, the number of the samples determined to have deteriorated insulation resistance was 11 out of 100. On the other hand, in Examples 1 to 8, the number of the samples determined to have deteriorated insulation resistance was 8 or less out of 100. In addition, in Examples 2 to 7, the number of the samples determined to have deteriorated insulation resistance was 4 or less out of 100, and in Examples 3 to 7, the number of the samples determined to have deteriorated insulation resistance was 4 or less out of 100. Furthermore, in Examples 4 to 6, the number of the samples determined to have deteriorated insulation resistance was 0 out of 100.

Therefore, it was discovered that the deterioration of the insulation resistance is reduced or prevented in a case where the exposure ratio is more than 0%. In addition, it was discovered that the deterioration of the insulation resistance is further reduced or prevented in a case where the exposure ratio is about 0.4% or more and about 83.4% or less. In addition, it was discovered that the deterioration of the insulation resistance is reduced or prevented even in a case where the exposure ratio is in a range of about 1.17% or more and about 83.4% or less and further, is in a range of about 1.40% or more and about 83.4% or less. Furthermore, it was discovered that the deterioration of the insulation resistance is further reduced or prevented in a case where the exposure ratio is about 1.40% or more and about 25.0% or less.

As described above, the example embodiments of the present invention are disclosed in the above description, but the present invention is not limited thereto.

That is, without departing from the scope of example embodiments and technical ideas of present invention, various changes can be made to the above-described example embodiments in terms of mechanisms, shapes, materials, quantities, positions, arrangements, and the like, and these are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer body including a plurality of stacked ceramic layers, a first main surface and a second main surface facing each other in a height direction, a first end surface and a second end surface facing each other in a length direction orthogonal or substantially orthogonal to the height direction, and a first side surface and a second side surface facing each other in a width direction orthogonal or substantially orthogonal to the height direction and the length direction;
a plurality of first inner electrode layers on the plurality of ceramic layers and extending to the first end surface;
a plurality of second inner electrode layers on the plurality of ceramic layers and extending to the second end surface;
a first outer electrode on the first end surface, extending from the first end surface to a portion of the first main surface, a portion of the second main surface, a portion of the first side surface, and a portion of the second side surface, and being connected to the first inner electrode layers; and
a second outer electrode on the second end surface, extending from the second end surface to a portion of the first main surface, a portion of the second main surface, a portion of the first side surface, and a portion of the second side surface, and being connected to the second inner electrode layers; wherein
the first outer electrode includes a first base electrode layer on the multilayer body, a first lower plating layer on the first base electrode layer, and a first upper plating layer on the first lower plating layer except for a first plating exposed region exposed on a surface of the first outer electrode so that the first lower plating layer includes the first plating exposed region; and
the second outer electrode includes a second base electrode layer on the multilayer body, a second lower plating layer on the second base electrode layer, and a second upper plating layer on the second lower plating layer except for a second plating exposed region exposed on a surface of the second outer electrode so that the second lower plating layer includes the second plating exposed region.

2. A multilayer ceramic electronic component comprising:
a multilayer body including a plurality of stacked ceramic layers, a first main surface and a second main surface facing each other in a height direction, a first end surface and a second end surface facing each other in a length direction orthogonal or substantially orthogonal to the height direction, and a first side surface and a second side surface facing each other in a width direction orthogonal or substantially orthogonal to the height direction and the length direction;
a plurality of first inner electrode layers on the plurality of ceramic layers and extending to the first end surface and the second end surface;
a plurality of second inner electrode layers on the plurality of ceramic layers and extending to the first side surface and the second side surface;
a first outer electrode on the first end surface, extending from the first end surface to a portion of the first main surface, a portion of the second main surface, a portion of the first side surface, and a portion of the second side surface, and being connected to the first inner electrode layers;
a second outer electrode on the second end surface, extending from the second end surface to a portion of the first main surface, a portion of the second main surface, a portion of the first side surface, and a portion of the second side surface, and being connected to the first inner electrode layers;
a third outer electrode on the first side surface, extending from the first side surface to a portion of the first main surface and a portion of the second main surface, and being connected to the second inner electrode layers; and
a fourth outer electrode on the second side surface, extending from the second side surface to a portion of the first main surface and a portion of the second main surface, and being connected to the second inner electrode layers; wherein
the first outer electrode includes a first base electrode layer on the multilayer body, a first lower plating layer on the first base electrode layer, and a first upper plating layer on the first lower plating layer except for a first plating exposed region exposed on a surface of the first outer electrode so that the first lower plating layer includes the first plating exposed region;
the second outer electrode includes a second base electrode layer on the multilayer body, a second lower plating layer on the second base electrode layer, and a second upper plating layer on the second lower plating layer except for a second plating exposed region exposed on a surface of the second outer electrode so that the second lower plating layer has the second plating exposed region;
the third outer electrode includes a third base electrode layer on the multilayer body, a third lower plating layer on the third base electrode layer, and a third upper plating layer on the third lower plating layer; and
the fourth outer electrode includes a fourth base electrode layer on the multilayer body, a fourth lower plating layer on the fourth base electrode layer, and a fourth upper plating layer on the fourth lower plating layer.

3. The multilayer ceramic electronic component according to claim 2, wherein
the third upper plating layer is provided on the third lower plating layer except for a third plating exposed region exposed on a surface of the third outer electrode so that the third lower plating layer includes the third plating exposed region; and
the fourth upper plating layer is provided on the fourth lower plating layer except for a fourth plating exposed region exposed on a surface of the fourth outer electrode so that the fourth lower plating layer has the fourth plating exposed region.

4. A multilayer ceramic electronic component comprising:
a multilayer body including a plurality of stacked ceramic layers, a first main surface and a second main surface facing each other in a height direction, a first end surface and a second end surface facing each other in a length direction orthogonal or substantially orthogonal to the height direction, and a first side surface and a second side surface facing each other in a width direction orthogonal or substantially orthogonal to the height direction and the length direction;
a plurality of first inner electrode layers on the plurality of ceramic layers and extending to the first end surface and the second end surface;
a plurality of second inner electrode layers on the plurality of ceramic layers and extending to the first side surface and the second side surface;
a first outer electrode on the first end surface, extending from the first end surface to a portion of the first main surface, a portion of the second main surface, a portion of the first side surface, and a portion of the second side surface, and being connected to the first inner electrode layers;
a second outer electrode on the second end surface, extending from the second end surface to a portion of the first main surface, a portion of the second main surface, a portion of the first side surface, and a portion of the second side surface, and being connected to the first inner electrode layers;
a third outer electrode on the first side surface, extending from the first side surface to a portion of the first main surface and a portion of the second main surface, and being connected to the second inner electrode layers; and
a fourth outer electrode on the second side surface, extending from the second side surface to a portion of the first main surface and a portion of the second main surface, and being connected to the second inner electrode layers; wherein
the first outer electrode includes a first base electrode layer on the multilayer body, a first lower plating layer on the first base electrode layer, and a first upper plating layer on the first lower plating layer;
the second outer electrode includes a second base electrode layer on the multilayer body, a second lower plating layer on the second base electrode layer, and a second upper plating layer on the second lower plating layer;
the third outer electrode includes a third base electrode layer on the multilayer body, a third lower plating layer on the third base electrode layer, and a third upper plating layer on the third lower plating layer except for a third plating exposed region exposed on a surface of the third outer electrode so that the third lower plating layer includes the third plating exposed region; and
the fourth outer electrode includes a fourth base electrode layer on the multilayer body, a fourth lower plating layer on the fourth base electrode layer, and a fourth upper plating layer on the fourth lower plating layer except for a fourth plating exposed region exposed on a surface of the fourth outer electrode so that the fourth lower plating layer includes the fourth plating exposed region.

5. The multilayer ceramic electronic component according to claim 1, wherein
a first ratio of an area of the first plating exposed region to an area of an exposed region of the first outer electrode on the first main surface when viewed in a direction of the first main surface is about 0.4% or more and about 83.4% or less; and
a second ratio of an area of the second plating exposed region to an area of an exposed region of the second outer electrode on the first main surface when viewed in the direction of the first main surface is about 0.4% or more and about 83.4% or less.

6. The multilayer ceramic electronic component according to claim 5, wherein the first ratio and the second ratio are about 1.17% or more and about 83.4% or less.

7. The multilayer ceramic electronic component according to claim 6, wherein the first ratio and the second ratio are about 1.40% or more and about 83.4% or less.

8. The multilayer ceramic electronic component according to claim 7, wherein the first ratio and the second ratio are about 1.40% or more and about 25.0% or less.

9. The multilayer ceramic electronic component according to claim 1, wherein the first plating exposed region is on the first main surface.

10. The multilayer ceramic electronic component according to claim 1, wherein a thickness of the first lower plating layer is about 2 μm or more and about 7 μm or less.

11. The multilayer ceramic electronic component according to claim 2, wherein
a first ratio of an area of the first plating exposed region to an area of an exposed region of the first outer electrode on the first main surface when viewed in a direction of the first main surface is about 0.4% or more and about 83.4% or less; and
a second ratio of an area of the second plating exposed region to an area of an exposed region of the second outer electrode on the first main surface when viewed in the direction of the first main surface is about 0.4% or more and about 83.4% or less.

12. The multilayer ceramic electronic component according to claim 11, wherein the first ratio and the second ratio are about 1.17% or more and about 83.4% or less.

13. The multilayer ceramic electronic component according to claim 12, wherein the first ratio and the second ratio are about 1.40% or more and about 83.4% or less.

14. The multilayer ceramic electronic component according to claim 13, wherein the first ratio and the second ratio are about 1.40% or more and about 25.0% or less.

15. The multilayer ceramic electronic component according to claim 2, wherein the first plating exposed region is on the first main surface.

16. The multilayer ceramic electronic component according to claim 1, wherein a portion of the first base electrode layer is exposed on the first main surface.

17. The multilayer ceramic electronic component according to claim 3, wherein at least one of a third ratio of an area of the third plating exposed region to an area of an exposed region of the third outer electrode on the first main surface when viewed in a direction of the first main surface and a fourth ratio of an area of the fourth plating exposed region to an area of an exposed region of the fourth outer electrode on the first main surface when viewed in the direction of the first main surface is about 0.4% or more and about 83.4% or less.

18. A mounting structure of a multilayer ceramic electronic component, comprising:
the multilayer ceramic electronic component according to claim 1; and
a mounting substrate on which the multilayer ceramic electronic component is mounted; wherein
the first plating exposed region is provided on the first main surface, and the multilayer ceramic electronic component is mounted such that the second main surface faces the mounting substrate.

19. A mounting structure of a multilayer ceramic electronic component, comprising:
the multilayer ceramic electronic component according to claim 2; and
a mounting substrate on which the multilayer ceramic electronic component is mounted; wherein
a positive potential is applied to the first outer electrode and the second outer electrode.

20. A mounting structure of a multilayer ceramic electronic component, comprising:
the multilayer ceramic electronic component according to claim 4; and
a mounting substrate on which the multilayer ceramic electronic component is mounted; wherein
a positive potential is applied to the third outer electrode and the fourth outer electrode.
